(19) United States
(12) Patent Application Publication
(10) Pub. No.: US 2022/0227624 A1
(43) Pub. Date: Jul. 21, 2022

(54) Method for Wet Chemical Synthesis of Lithium Argyrodites

(71) Applicants: Dominika Agnieszka BUCHBERGER, Warsaw (PL); University of Louisville Research Foundation, Inc., Louisville, KY (US); Uniwersytet Warszawski, Warsaw (PL)

(72) Inventors: Hui Wang, Louisville, KY (US); Thad Druffel, Louisville, KY (US); Dominika Agnieszka Buchberger, Warsaw (PL)

(73) Assignees: University of Louisville Research Foundation, Inc., Louisville, KY (US); Uniwersy tet Warszawski, Warsaw (PL)

(21) Appl. No.: 17/604,096

(22) PCT Filed: Apr. 16, 2020
(86) PCT No.: PCT/US2020/028471

§ 371 Date: Oct. 15, 2021

Related U.S. Application Data
(60) Provisional application No. 62/835,173, filed on Apr. 17, 2019.

(51) Int. Cl. C01B 17/22; H01M 10/0525; H01M 10/0562

(52) U.S. Cl. CPC C01B 17/22; H01M 10/0525; H01M 10/0562; H01M 2300/008; C01P 2006/40; C01P 2002/72; C01P 2004/03; C01P 2002/82; C01P 2002/85; H01M 2220/20

(57) ABSTRACT

Methods for wet chemical synthesis of lithium argyrodites are provided, which in some embodiments include includes dissolving a stoichiometric mixture of precursors in a small quantity of solvent in an argon atmosphere, drying the mixture under vacuum or an inert gas atmosphere to evaporate the solvent, and then annealing to obtain a final lithium argyrodite product. Further embodiments comprise synthesizing the precursors, and excess halide doping to achieve higher ionic conductivity.

### CROSS-REFERENCE TO RELATED APPLICATIONS

This international patent application claims the benefit of and priority to U.S. Provisional Patent Application Ser. No. 62/835,173, with a filing date of 17 Apr. 2019, the contents of which are fully incorporated herein by reference.

### STATEMENT OF GOVERNMENT RIGHTS

This invention was made with United States Government support under Grant No. 1355438 awarded by the National Science Foundation. The United States Government has certain rights in the invention.

### FIELD OF INVENTION

The embodiments described herein include methods for rapidly and economically synthesizing solid electrolytes for use in battery systems, further embodiments relate to wet chemical synthesis of lithium argyrodites and the use of halide doping.

### BACKGROUND

The rapidly growing electric vehicle industry has spurred a strong need for the development of safer and higher energy density portable energy storage. Currently, conventional liquid electrolyte batteries, such as lithium ion, are in use for such applications. However, conventional liquid electrolyte batteries have limited energy density and thus limited energy capacity. In addition, conventional liquid electrolyte batteries are highly flammable and unstable. As a result, conventional liquid electrolyte batteries present a significant safety hazard, especially to the electric vehicle industry. Furthermore, conventional liquid electrolyte batteries often decompose at high voltages, which limit the use of high voltage cathode materials, and they often pose a risk of leakage.

All-solid-state batteries (ASSBs), on the other hand, have shown promise as next-generation lithium battery systems that address many of the drawbacks of the conventional liquid electrolyte batteries. ASSBs are promising candidates for the battery storage industry and are expected to improve safety, increase energy density, and enhance stability and durability. ASSBs comprise solid electrodes and solid electrolytes, instead of the liquid or polymer electrolytes found in the typical lithium ion battery. The solid electrolyte is an important component of ASSBs for its role in transporting the lithium ions and separating the anode from the cathode. Common inorganic solid electrolytes include oxides (e.g., garnet, perovskite), phosphates (e.g., LiPON, LATP, LAGP) and sulfides (e.g., Li₂S—P₂S₅, Li₃PS₄, Li₇P₃S₁₁, Li₇PS₆). Among these, sulfide solid electrolytes have garnered significant attention due to their superior lithium ion conductivities, wide electrochemical window, thermal stability, and favorable mechanical properties such as easy densification and elastic modulus. Other desirable properties for a solid electrolyte include an ionic conductivity above 10⁻⁴ Siemens per centimeter (S cm⁻¹) at room temperature, a large electrochemical stability window, and stability against electrodes, especially a metallic lithium anode. In addition, the production cost is an important factor in the large-scale development of solid electrolyte materials.

Lithium argyrodites are a new and promising class of solid electrolyte sulfide-based lithium ion superconductors. Lithium argyrodites originate from the silver germanium sulfide mineral with the formula Ag₈GeS₆, which is characterized by its high ionic conductivity (˜10⁻³ S cm⁻¹) and fast silver ion (Ag+) mobility. Pure lithium argyrodite (Li₇PS₆) is reported to have a cubic phase at high-temperature (HT) or an orthorhombic phase at low-temperature (LT). In particular, the cubic HT-phase shows higher ionic conductivities (0.7-1.0 10⁻³ S cm⁻¹) and can be stabilized by the replacement of the sulfur by halogen anions, such as chlorine, bromine, and iodine. Such lithium argyrodites are expressed by the formula LiₘPSₙXₒ, where X is either chlorine, bromine, or iodine. Lithium argyrodites without a halide are expressed by the formula LiₘPSₙ.

Recent studies of lithium argyrodite materials have yielded a basic understanding of the temperature-dependent diffusion paths of ions based on their structural properties. In addition, strong interest has grown in the use of lithium argyrodites as solid electrolytes for ASSBs because of its (1) high intrinsic lithium-ion conductivities (10⁻² to 10⁻³ S cm⁻'), (2) impressive stability within a large electrochemical window (up to 7V, which is suitable even for high voltage cathode materials), and (3) composition flexibility (due to flexibility in both anion and cation doping).

Despite these important findings, however, the large-scale manufacturing of lithium argyrodites has not been achieved due to the harsh conditions required by the conventional synthesis methods: melt-quenching or high-energy ball milling. With these conventional approaches, Li₇PS₆ (as one example) has been synthesized through the solid-state reaction of Li₂S with P₂S₅ at 550° C. for several hours or even days. Moreover, the preparation conditions for melt-quenching are very difficult and harsh. For example, melt-quenching requires the careful and precise control of reactant concentrations, otherwise it results in impurities during the cooling process. Consequently, the industrial applicability and feasibility of the conventional melt-quenching synthesis method has shown limited to unlikely prospects. High-energy ball milling fabrication is also time consuming and it is difficult to obtain uniform products. For example, some conventional ball-milling methods require at least 5 hours and up to 4 days to complete (without accounting for the time required to complete full crystallization). For the entire crystallization process to be completed after the heating and cooling cycle, the conventional ball-milling method can take an additional 5 hours and up to 7 days.

Recently, wet chemical synthesis has attracted interest as an alternative to the conventional synthesis methods because of its flexibility for material preparation and manufacturing simplicity. However, the conventional wet chemical synthesis methods require expensive solvents such as tetrahydrofuran (THF), acetonitrile (ACN), and dimethoxyethane (DME). For the large-scale synthesis of lithium argyrodites, which is required for the development of ASSBs in next generation energy storage systems, lesser amounts of solvents, as well as inexpensive and less toxic would be preferred. Moreover, liquid synthesis for producing lithium argyrodites is always challenging due to the stability of precursors in a solvent; for example, P₂S₅ reacts with the ethanol to form dialkyl dithiophosphoric acid.

In addition, non-toxic solvent based liquid synthesis would be a more efficient and environmentally friendly approach to prepare homogenous composite cathodes for ASSBs. Typically, cathode materials have poor conductivities and require mixing with carbon/solid electrolyte to enhance their electronic/ionic conductivities. For example, melt-quenching and high-energy ball milling typically results in the aggregation of each component, and such fouling limits the efficiency and life cycle duration of electrodes used in synthesis of lithium argyrodites.

Furthermore, the conventional solid-state synthesis methods have not explored the impact of halide doping content on the structure and conductive properties of produced lithium argyrodite. This limitation may be due to the difficulty in introducing additional halide(s) into a lithium argyrodite structure utilizing the traditional solid-state synthesis methods because of the slow atom diffusion and lattice reorganization.

Accordingly, there is a significant need for more optimal solid electrolyte synthetic methods capable of producing lithium argyrodites on the commercial scale, i.e. kgs or higher. There is also a significant need for a synthetic method that is simpler, more efficient, requires shorter preparation times, results in more homogenous products with higher conductivities, and utilizes more environmentally friendly and affordable solvents. Such improvements would allow for the success of ASSBs at scales large enough to serve the mobile electric market. Along with other features and advantages outlined herein, the methods described herein according to multiple embodiments and alternatives meet these and other needs. In doing so, the methods described herein further advance the use of Li-ion conducting argyrodites in ASSBs by producing improved halide doped materials.

### SUMMARY OF EMBODIMENTS

Multiple embodiments and alternatives are disclosed herein for the liquid synthesis of lithium argyrodites using precursors and inexpensive and nontoxic ethanol (EtOH) solvent. Although EtOH is preferred, other solvents also can be used within the scope of present embodiments, which provide for, without limitation, a method for rapid synthesis of lithium argyrodites in about 2 hours and at low sintering temperatures (e.g. 150° C.). According to multiple embodiments and alternatives, structural and morphological investigations have determined that the synthesized lithium argyrodites have high phase purity, improved ionic conductivity at room temperature, high stability, and homogeneity. In some embodiments, halide doping occurs during the synthesis process to achieve higher ionic conductivity.

In some embodiments, the electrolyte Li₇PS₆ is synthesized by dissolving the precursors Li₂S and β-Li₃PS₄ in a small quantity of anhydrous ethanol (e.g. 25 ml) in argon atmosphere. Next, in some embodiments the mixture is dried above room temperature (e.g. greater than 22° C.) under vacuum to evaporate the solvent yielding a white precipitate (not longer than 1 hour, preferably 40-50 minutes), and then treated above 150° C. for 1 hour to obtain the final product (Li₇PS₆). In some embodiments, establishing a negative pressure of 10⁻²˜10⁻³ mbar or lower provides efficient evaporation. In some embodiments, instead of a vacuum, the mixture is dried above room temperature in an inert gas atmosphere until a dry powder is obtained. In the synthesis of Li₇PS₆ noted above, the chemical reaction of β-Li₃PS₄ and Li₂S is:

$$L {i}_{3} P {S}_{4} + 2 L {i}_{2} S {\to }^{etha nol} {Li}_{7} P {S}_{6} \qquad Equation ( 1 )$$

The Li₇PS₆ product synthesized according to multiple embodiments and alternatives exhibits high phase purity, favorable ionic conductivity, and significant electrochemical stability with metallic lithium anode. In some embodiments, methods for wet chemical synthesis provided herein utilize the economic and nontoxic ethanol solvent to synthesize lithium argyrodite solid electrolyte in significantly shorter time than conventional approaches.

Present embodiments include those wherein steps include synthesis of electrolytes Li₆PS₅X (where X=Cl, Br, or I) by dissolving a stoichiometric mixture of Li₂S, Li₃PS₄ in acetonitrile (i.e., (ACN)₂ in this exemplary statement)) and LiX (X=Cl, Br, I) in a small quantity of anhydrous ethanol (25 ml) in argon atmosphere. In an exemplary embodiment, the Li₃PS₄.(ACN)₂ precursor is used (or pure Li₃PS₄, or Li₃PS₄.(THF)), then the solvent is evaporated above room temperature (e.g. more than 22° C.) under vacuum (not longer than 1 hour, preferably 40-50 minutes), and the precipitate then is treated with heat (above 150° C. for 1 hour) until the final product is synthesized (e.g. Li₆PS₅Cl, Li₆PS₅Br, and Li₆PS₅I). The chemical reaction is:

$$L {i}_{3} P {S}_{4} + L {i}_{2} S + LiX {\to }^{etha nol} {Li}_{6} P {S}_{5} X \qquad Equation ( 2 )$$

Structural and morphological investigations revealed the final product exhibits high phase purity, high ionic conductivity at room temperature, and good stability with metallic lithium without evidence of side reactions.

In some embodiments according to the present disclosure, Li₆PS₅Cl.xLiCl (0≤x≤2) materials were synthesized by stoichiometrically tuning an excess amount of LiCl as the precursor. According to multiple embodiments and alternatives, the synthesized product has a molar ratio of sulfur to chloride in the range of 1.5:1 to 5.1. In some embodiments, the synthesized product has a molar ratio of sulfur to chloride in the range of 2.5:1 to 5:1. An exemplary process includes first dissolving Li₂S and LiCl in ethanol, followed by the addition of Li₃PS₄. Next, the mixture is stirred for 0.5 hours, dried above room temperature (e.g. 90° C. as a non-limiting example) under vacuum to evaporate the ethanol, and then annealed above 150° C. As desired, chlorine content in Li₆PS₅Cl.xLiCl (0≤x≤2) is tuned by controlling the amount of LiCl precursor. In some embodiments, the following ratios of LiCl:Li₃PS₄ were controlled at 1:1, 1.5:1, 2:1, 2.5:1, and 3:1 to obtain the samples of Li₆PS₅Cl, Li₆PS₅Cl.0.5LiCl (i.e. Li_{6.5}PS₅Cl_{1.5}), Li₆PS₅Cl.LiCl (i.e. Li₇PS₅Cl₂), Li₆PS₅Cl.1.5LiCl (i.e. Li_{7.5}PS₅Cl_{2.5}) and Li₆PS₅Cl.2LiCl (i.e. Li₈PS₅Cl₃), respectively. To investigate the annealing effect, Li₆PS₅Cl.LiCl sample was heated at different temperatures (350° C., 550° C. as non-limiting examples) for 6 hours under an Argon environment, according to multiple embodiments and alternatives. Herein, the annealed samples are referred to as Li₆PS₅Cl.LiCl-350 and Li₆PS₅Cl.LiCl-550, respectfully. The chemical reaction is represented by:

$$( x + 1 ) LiCl + L {i}_{3} P {S}_{4} + L {i}_{2} S {\to }^{etha nol} {Li}_{6} P {S}_{5} Cl \cdot xLiCl \qquad Equation ( 3 )$$

Advantageously, it has been discovered that when the Cl doping ratio is 2:1 (versus Li₃PS₄), the synthesized lithium argyrodite solid electrolyte exhibits a higher ionic conductivity of 4.4×10⁻⁴ S cm⁻¹ at room temperature when compared to other Cl doping ratios studied. The inventors are unaware of any reported conductivity value higher than this for an argyrodite prepared via liquid synthesis. In addition, the synthesized lithium argyrodite exhibits stability against a metallic lithium anode and lower activation energy.

The liquid synthesis method according to multiple embodiments and alternatives opens new possibilities for the success of ASSBs by generating lithium argyrodites with higher purity and more homogenous material through a simpler and scalable manufacturing process.

### BRIEF DESCRIPTION OF THE FIGURES

The drawings and embodiments described herein are illustrative of multiple alternative structures, aspects, and features of the multiple embodiments and alternatives disclosed herein, and they are not to be understood as limiting the scope of any of these embodiments and alternatives. It will be further understood that the drawing figures described and provided herein are not to scale, and that the embodiments are not limited to the precise arrangements and instrumentalities shown.

FIG. 1 is a flow chart showing the steps of a method for wet chemical synthesis of lithium argyrodites

FIG. 2 shows a comparison of x-ray diffraction patterns (XRD) of Li₇PS₆ crystalline and β-Li₃PS₄ phase [panel (a)], and Raman spectra of Li₇PS₆ and β-Li₃PS_{4 [}panel (b)].

FIG. 3 shows scanning electron microscope (SEM) images of SEM images of the final Li₇PS₆ product [panel (a)] and Li₃PS₄ precursor [panel (b)].

FIG. 4 shows energy-dispersive X-ray spectroscopy (EDX) maps of Li₃PS₄ precursor prepared from ACN solution, wherein [panel (a)] shows the distribution of P atoms and [panel (b)] shows the distribution of S atoms. FIG. 4 also shows EDX maps of the final Li₇PS₆ product prepared from ethanol solution, wherein [panel (c)] shows the distribution of P atoms and [panel (d)] shows the distribution of S atoms.

FIG. 5 shows Arrhenius plots of Li₇PS₆ from ethanol and β-Li₃PS₄ from ACN [panel (a)], and comparison of conductivity values and synthesis time of Li₇PS₆ prepared by different methods [panel (b)].

FIG. 6 shows cyclic voltammetry curves of Li₇PS₆ and β-Li₃PS₄ solid electrolytes with metallic Li anode with Li/SE/Pt cell (scanning rate at 50 mV s⁻¹ between −0.5 and 5V vs. Li/Li⁺ at room temperature) [panel (a)], and cycling performance of Li/Li₇PS₆/Li symmetric cell (current density of 50 μA cm⁻²) [panel (b)].

FIG. 7 is a flow chart illustrating the steps of a method for wet chemical synthesis of lithium argyrodites.

FIG. 8 shows XRD patterns of Li₇PS₆ solid electrolyte using different precursors: Li₃PS₄.(ACN)₂ complex and Li₃PS₄.

FIG. 9 shows XRD patterns of Li₇PS₆ obtained from ethanol evaporation and dried at 90 ° C.

FIG. 10 shows XRD patterns of Li₃PS₄.(ACN)₂ fresh precipitate and after 80° C. heat treatment, and β-Li₃PS₄ phase above 150° C. annealing.

FIG. 11 shows XRD patterns of re-precipitated Li₃PS₄ material from ethanol dried at 80° C. and heated above 150° C., as well as reference patterns for Li₃PS₄ and Li₃PS₄.(ACN)₂.

FIG. 12 shows Raman spectra of Li₃PS₄, Li₃PS₄ re-precipitated from EtOH, and Li₇PS₆ prepared from Li₃PS₄ and Li₂S in EtOH medium.

FIG. 13 shows SEM images of the re-precipitated Li₃PS₄ sample from ethanol, wherein [panel (a)] has 5 μm scale and [panel (b)] has a 2 μm scale.

FIG. 14 shows Nyquist plots of synthesized Li₇PS₆ and β-Li₃PS₄ precursor, wherein the frequency range is from 1 MHz to 100 mHz.

FIG. 15 shows XRD patterns of Li₇PS₆ pellet after cycled in a symmetric cell (Li/Li₇PS₆/Li).

FIG. 16 is a flow chart showing the steps of a method for wet chemical synthesis of lithium argyrodites.

FIG. 17 shows XRD patterns of Li₇PS₆ and Li₆PS₅X lithium argyrodites, wherein [panel (b)] is a close-up view of [panel (a)]. The dashed lines vertical lines in the bottom of [panel (a)] refer to standard diffraction peaks for Li₆PS₅X.

FIG. 18 shows Raman spectra of Li₇PS₆ and Li₆PS₅X lithium argyrodites (X=Cl, Br, or I) from ethanol solution and Li₂S and P₂S₅ for comparison.

FIG. 19 shows SEM images of Li₇PS₆ [panel (a)] and Li₆PS₅X products prepared from ethanol solution, where X is Cl [panel (b)], Br [panel (c)], and I [panel (d)].

FIG. 20 shows Arrehenius plots of Li₇PS₆ and Li₆PS₅X lithium argyrodite samples from ethanol.

FIG. 21 panel shows cyclic voltammetry curves [panel (a)] of the liquid synthesized Li₆PS₅X materials with metallic Li anode in the voltage window of 0.5-5.0 (vs Li/Li+) and the cycling performance of symmetric cells under a current density of 0.02 mA cm⁻² [panel (b)].

FIG. 22 shows cycling of symmetric cells with Li/Li₆PS₅X/Li structure, wherein [panel (b)] is a close-up view of a portion of [panel (a)].

FIG. 23 shows EDX maps of Li₆PS₅X products (where X is Cl, Br and I) prepared form ethanol solution showing the distribution of S, P, and X atoms.

FIG. 24 shows multiple unit cell three-dimensional simulation of the crystal structure of certain Li₆PS₅X products (where X is Cl [panel (a)], Br [panel (b)] and I [panel (c)]).

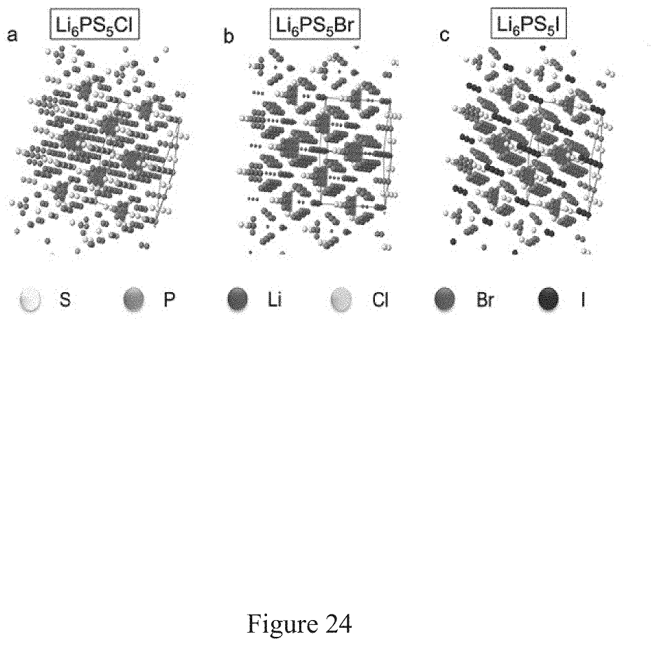

FIG. 25 shows XRD patterns of Li₇PS₆ and Li₆PS₅X (X=Cl, Br, I) using Li₃PS₄ from THF solvent.

FIG. 26 shows Arrehenius plots of Li₇PS₆ and Li₆PS₅Cl using different Li₃PS₄ precursors (from THF solvent or ACN).

FIG. 27 shows a SEM image of Li₆PS₅Cl.

FIG. 28 shows the XRD patterns [panel (a)] and the Raman spectra [panel (b)] for lithium argyrodites with different Cl contents.

FIG. 29 shows the XRD patterns [panel (a)] and analysis of the Li₆PS₅Cl.LiCl sample after annealing heat treatment under different temperatures [panel (b)].

FIG. 30 shows SEM images of the lithium argyrodites with different Cl contents produced in accordance with inventive methods disclosed herein, wherein [panel (a)] is the SEM image for Li₆PS₅Cl.LiCl, [panel (b)] is the SEM image for Li₆PS₅Cl.2LiC1, and [panel (c)] is the EDX mapping of Li₆PS₅Cl.LiCl.

FIG. 31 shows Arrhenius plots of solvent-synthesized lithium argyrodites (Li₇PS₆ and Li₆PS₅Cl.xLiCl with x=0, 0.5, 1, 1.5 and 2) [panel (a)] and also shows composition dependence of room temperature conductivities and activation energies for lithium argyrodites with excess Cl content [panel (b)].

FIG. 32 shows cyclic voltammetry curves under scanning rate of 50 mV/s in the range of −0.5-5.0V (vs Li/Li⁺) [panel (a)], and the cycling performance of symmetric cells (current density of 0.02 mA cm⁻²) [panel (b)] for the LiₘPSₙClₒ samples with different Cl content (0<o<3).

FIG. 33 [panel (a)] shows Nyquist plots of lithium argyrodites with different Cl content Li₇PS₆ and Li₆PS₅Cl.xLiCl (x=0, 0.5, 1, 1.5, 2) at room temperature and [panel (b)] compares the Nyquist plots of Li₆PS₅Cl and Li₆PS₅Cl.LiCl.

FIG. 34 shows the cyclic voltammetry curve of Li₅PS₄Cl₂ solid electrolyte in large voltage window up to 10 V (vs Li/Li⁺).

FIG. 35 shows the symmetric cells cycling voltage profiles for Li₇PS₆ solid electrolyte under different current densities (0.02, 0.03, and 0.05 mA cm⁻¹).

FIG. 36 shows the symmetric cells cycling voltage profiles for Li₆PS₅Cl solid electrolyte under different current densities (0.02, 0.03, and 0.05 mA cm⁻¹).

FIG. 37 shows the symmetric cells cycling voltage profiles for Li₅PS₄Cl₂ solid electrolyte under different current densities (0.02, 0.03, and 0.05 mA cm⁻¹).

FIG. 38 shows the symmetric cells cycling voltage profiles for Li₆PS₅Cl.LiCl solid electrolyte under different current densities (0.02, 0.03, and 0.05 mA cm⁻¹).

FIG. 39 shows the comparison of battery cycling performance of Li/LTO cells with Li₆PS₅Cl.LiCl and Li₆PS₅Cl as the solid electrolyte composition under 0.2 C.

### MULTIPLE EMBODIMENTS AND ALTERNATIVES

Methods for wet chemical synthesis of lithium argyrodites, according to multiple embodiments and alternatives, opens new possibilities for synthesizing highly pure and homogenous materials through a simple and scalable manufacturing process. Compared to conventional synthesis methods, methods presented herein according to multiple embodiments and alternatives are scalable, more efficient, easier to prepare, have a shorter synthesis time, and utilize an environmentally friendly and affordable solvent (e.g, ethanol). Moreover, the synthesized product according to multiple embodiments and alternatives exhibits high phase purity, excellent room temperature ionic conductivity, and high stability. Accordingly, inventive methods for wet chemical synthesis of lithium argyrodite as described herein may allow for the success of ASSBs at scales that are practical for serving the mobile electric vehicle market.

According to multiple embodiments and alternatives, a method for wet chemical synthesis of lithium argyrodites involves dissolving a stoichiometric mixture of precursors (Li₂S, Li₃PS₄.(ACN)₂ and LiX [where X=Cl, Br, I] as non-limiting examples) in a small quantity of ethanol in an argon atmosphere. Next, drying the mixture above room temperature (i.e. greater than 22° C.) under vacuum, or in an inert gas atmosphere, to evaporate the ethanol (no longer than 1 hour, preferably 40-50 minutes), then annealing above 150° C. for one hour obtains a final lithium argyrodite product. Further embodiments comprise synthesizing the precursors by dissolving Li₂S and P₂S₅ in ACN, stirring the mixture for eight hours at room temperature, and then filtering the product. The obtained white powder is then dried at 80° C. under vacuum (Li₃PS₄.(ACN)₂) followed by a heat treatment above 150° C. (β-Li₃PS₄). Further embodiments comprise the use of halide doping by modifying the ratios of LiCl vs. Li₃PS₄. According to multiple embodiments and alternatives, an argyrodite prepared with an excess amount of 2 moles of chloride achieves a desirable ionic conductivity at room temperature. It is expected that bromine or iodine doping will have a similar impact on increasing the ionic conductivity of the argyrodite.

According to multiple embodiments and alternatives, the synthesized argyrodites can be utilized as the electrolyte in an electrochemical energy storage device (such as an ASSB as a non-limiting example). In some embodiments, the electrochemical energy storage device comprises an anode, a cathode, and the synthesized argyrodite as the electrolyte. The anode releases electrons to the circuit and oxides during the electrochemical reaction, the cathode acquires electrons from the external circuit and is reduced during the electrochemical reaction, and the electrolyte is the medium that acts as the ionic conductor. ASSBs utilizing solid electrolyte compositions, prepared according to multiple embodiments and alternatives, achieve a desirable specific capacity likely due to the formation of a more stable solid electrolyte interphase layer and by blocking side reactions.

All examples provided herein are meant as illustrative of various aspects of multiple embodiments and alternatives of wet chemical synthesis of lithium argyrodites. These examples are non-limiting and merely characteristic of multiple alternative embodiments as described and claimed or to-be-claimed herein.

### Example 1—Wet Chemical Synthesis of Li₇PS₆

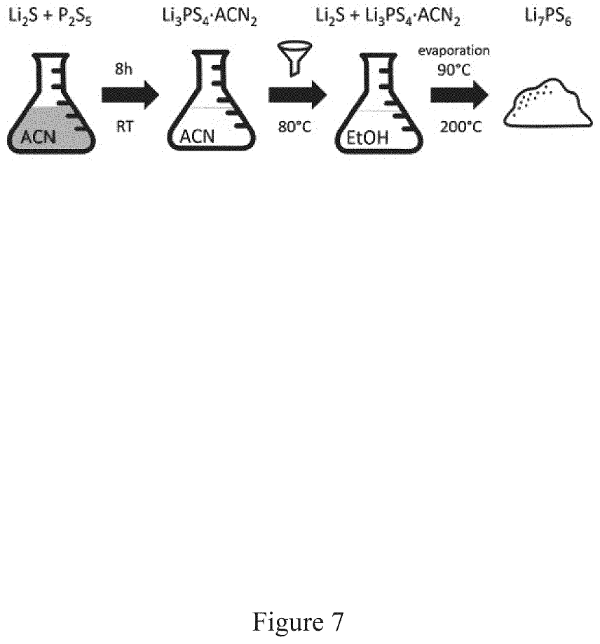

Synthesis of Li₃PS₄ precursor—As illustrated in FIG. 7, the Li₂S and P₂S₅ with a stoichiometry of 3:1 is dissolved in acetonitrile (ACN), stirred for 8 h at room temperature and then filtrated. The obtained white powder is then dried at 80° C. under vacuum to remove excess solvent yielding Li₃PS₄.(ACN)₂. Further heat treatment above 150° C. produces β-Li₃PS₄.

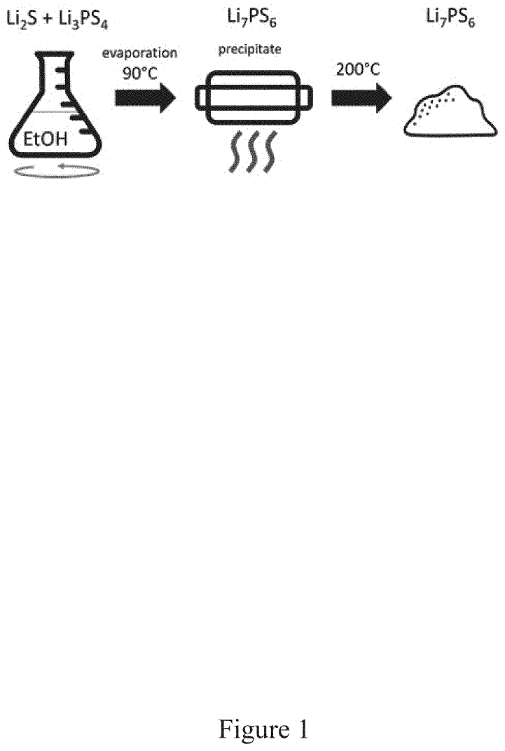

Synthesis of Li₇PS₆electrolyte—As illustrated in FIG. 1, a stoichiometric mixture (2:1 molar) of Li₂S and β-Li₃PS₄ is dissolved in a small quantity of anhydrous ethanol (25 ml) in argon atmosphere. Next, the mixture is dried above room temperature (i.e. greater than 22° C.) under vacuum or an inert gas atmosphere to evaporate the solvent yielding a white precipitate (not longer than 1 hour, preferably 40-50 minutes), and then treated above 150° C. for 1 hour to obtain a final product (Li₇PS₆). As previously noted, the chemical reaction of β-Li₃PS₄ and Li₂S to produce cubic Li₇PS₆ is:

$$L {i}_{3} P {S}_{4} + 2 L {i}_{2} S {\to }^{EtOH} {Li}_{7} P {S}_{6} \qquad Equation ( 1 )$$

Structural and Morphological Investigation—The phase composition and crystal structure of the Li₇PS₆ electrolyte synthesized within the scope of embodiments were analyzed using X-ray diffraction (XRD) (Broker D8 Discover) with nickel-filtered Cu-Kα radiation (λ=1.5418 Å). The Scherrer equation was used to estimate the crystallite size of the obtained materials. The Scherrer equation, when utilized in XRD, is a formula that relates the size of crystallites in a solid to the broadening of a peak in a diffraction pattern. The Scherrer equation is a simple and well-known expression for obtaining a measure of the crystallite size from XRD peaks. The Scherrer equation is represented by the following formula:

τ=(Kλ)/(βcos θ) Equation (4)

where τ is the mean size of the ordered (crystalline) domains, K is a dimensionless shape factor, λ is the X-ray wavelength, β is the line broadening at half the maximum intensity (FWHM), after subtracting the instrumental line broadening, in radians, and θ is the Bragg angle.

The chemical and structural data was obtained from the Raman spectroscopy, which was measured using Renishaw in Via Raman/PL Microscope and a 632.8 nm emission line of a HeNe laser. Raman spectroscopy is a technique used to observe vibration, rotational, and other low-frequency modes in a system. Typically, a sample is illuminated with a laser beam, then electromagnetic radiation from the illuminated spot is collected with a lens and sent through a monochromator. Elastic scattered radiation at the wavelength corresponding to the laser line is filtered out by either a notch filter, edge pass filter, or a band pass filter, while the rest of the collected light is dispersed onto a detector.

General morphologies of all samples were also investigated using a TESCAN Vega3 scanning electron microscope (SEM).

Conductivity and Electrochemical Stability—Electrochemical impedance spectroscopy (EIS) was carried out to measure the ionic conductivities of samples, synthesized within the scope of embodiments, in the frequency range from 1 MHz to 100 mHz with an amplitude of 100 mV using Bio-Logic VSP300. For the measurements, dense pellets (½″ diameter) were prepared by cold pressing the powder with C/Al as blocking electrodes at each side and placed in Swagelok cells. A Swagelok cell is typically a cylindrical battery cell that is widely known to one of ordinary skill in the art.

As expected for pure ionic conductors, EIS spectra present a semi-arc at high frequencies and a straight line at lower frequencies. The intercept of a straight line at the axis is employed to determine the total ionic conductivity of the material. In addition, the temperature dependent spectra were recorded from room temperature (i.e. about 22° C.) to 90° C. to obtain the Arrhenius plot. An Arrehenius plot displays the logarithm of a reaction rate constant plotted against inverse temperature.

Swagelok cells were also used to complete cyclic voltammetry (CV) and cycling performance measurements. A CV test is an electrochemical technique which measures the current that develops in an electrochemical cell under conditions where voltage is in excess of the predicted amount. For the CV test, Li/SE/Pt cells were scanned at 50 mV s′ rate between 0.5 and 5V vs. Li/Li⁺ at room temperature using Bio-Logic VSP 300 potentiostat. For symmetric cell cycling, the Li/SE/Li symmetric cell were assembled and cycled on a battery system (Bio-Logic VSP) with current densities of 50 μA cm⁻².

### Results and Discussion

### Structural Analysis

In this Example, Li₇PS₆ solid electrolyte was synthesized by reacting Li₃PS₄ and Li₂S in an anhydrous ethanol, and subsequent heat treatment at low temperature (as shown in FIG. 1), according to multiple embodiments and alternatives. Li₃PS₄ has a similar solubility as Li₂S in ethanol and thus made the Li₇PS₆ reaction possible.

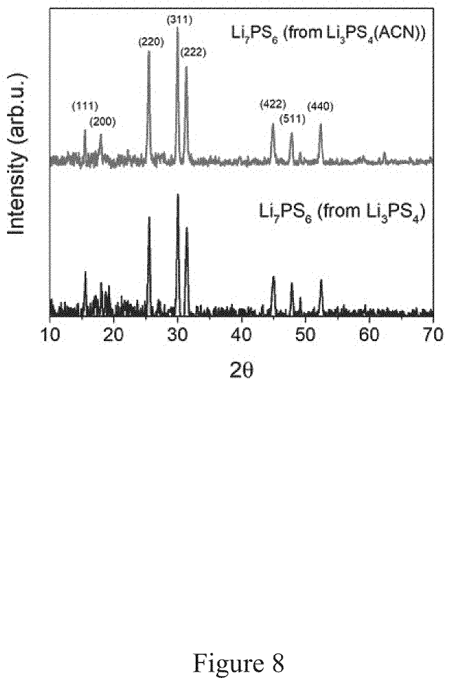

As shown in FIG. 7, the pure phase of Li₇PS₆ product was also obtained by using Li₃PS₄.(ACN)₂ complex as the precursor to react with Li₂S in ethanol. FIG. 8 illustrates the XRD patterns of Li₇PS₆ solid electrolyte using different precursors: Li₃PS₄.ACN)₂ complex and Li₃PS₄. FIG. 8 shows that the source of Li₃PS₄ has no difference on the Li₇PS₆ phase purity and expands to Li₃PS₄ synthesized from other solid-state methods.

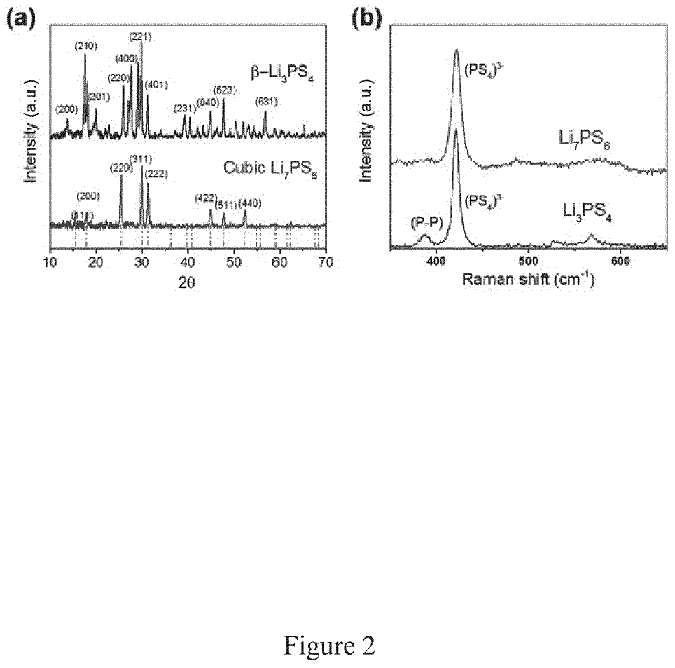

As shown in FIG. 2 (panel a), the as-synthesized Li₇PS₆ powder was characterized by XRD. Interestingly, the Li₇PS₆ powder synthesized according to multiple embodiments and alternatives displays several sharp peaks at 2θ=25.5, 30, 31.2°, corresponding to (220), (311) and (222) planes in cubic HT-phase of Li₇PS₆ (space group F-43m). These characteristic diffraction peaks shown in FIG. 2 align with the pure phase of cubic Li₇PS₆ that has been reported previously. The cubic structure of the synthesized product has a unit cell parameter equal to 9.88 Å and the crystal size is estimated at 34 nm. As shown in FIG. 2 (panel a), Li₇PS₆ shows totally different diffraction patterns than orthorhombic β-Li₃PS₄ (space group Pnma, a=12.997 Å, b=8.081 Å, c=6.143 Å). Furthermore, due to stoichiometric amounts of reactants and a homogeneity of the liquid preparation method, the final material is free from Li₂S impurity and other crystal phases.

The Raman spectra of cubic Li₇PS₆ and β-Li₃PS₄ are shown in FIG. 2 (panel b). The precursor Li₃PS₄ exhibits a peak at 421.1 cm⁻¹ and this can be attributed to symmetric stretching vibration of (PS₄)³⁻ (ortho-thiophosphate) group in orthorhombic β-Li₃PS₄ structure. Furthermore, a few minor lines at 387.6, 530.2 and 568.5 cm⁻¹ are observed, where the first mode corresponds to a trace of Li₄P₂S₆ and its (P₂S₆)⁴ (P—P bond) vibrational mode, and the latter two refer to the additional (PS₄)⁻³ vibrational modes. After the reaction, Li₇PS₆ shows a PS₄⁻³ vibrational mode at 421.6 cm⁻¹ as expected. A small peak at 497.2 cm⁻¹ and broad line around 575 cm⁻ are probably attributable to, similarly to Li₃PS₄ structure, the additional (PS₄)⁻³ vibrational modes. Due to a strong ionic character of bonds between S⁻² and Li⁺ ions in the crystal Raman, the lines from Li⁺—S⁻² interaction are expected to be weak.

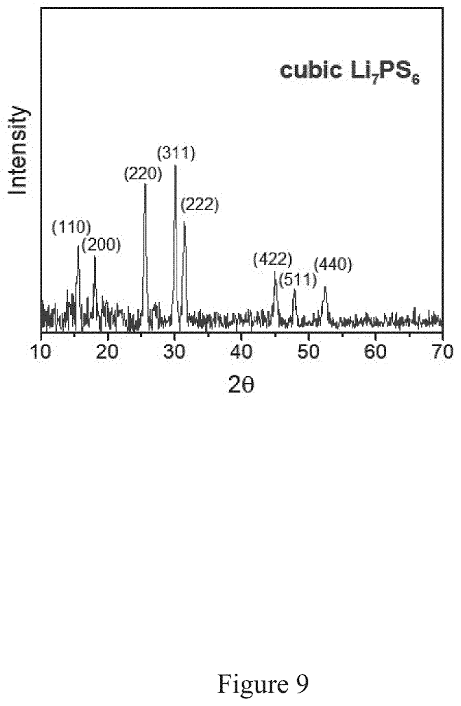

The XRD pattern of intermediate product after the evaporation of EtOH (as illustrated in FIG. 9), shows that pure phase of Li₇PS₆ exists before heat treatment at 200° C., suggesting that this reaction happens at room temperature without heating. This also indicates that Li₇PS₆ is unlikely to form an adduct with ethanol, which makes it easy to remove the solvent.

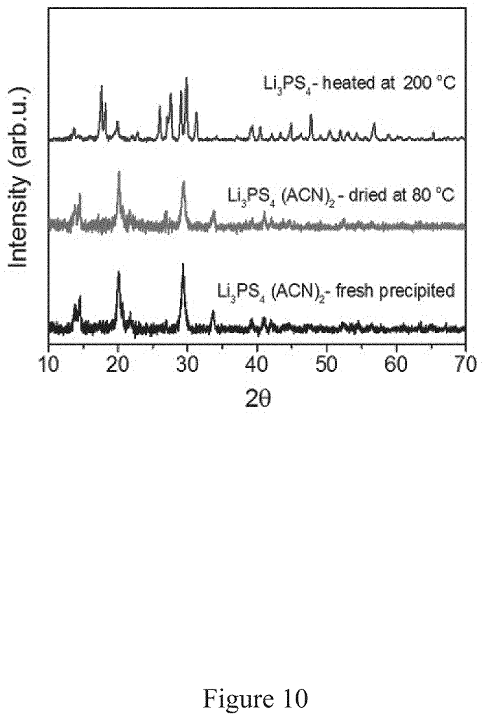

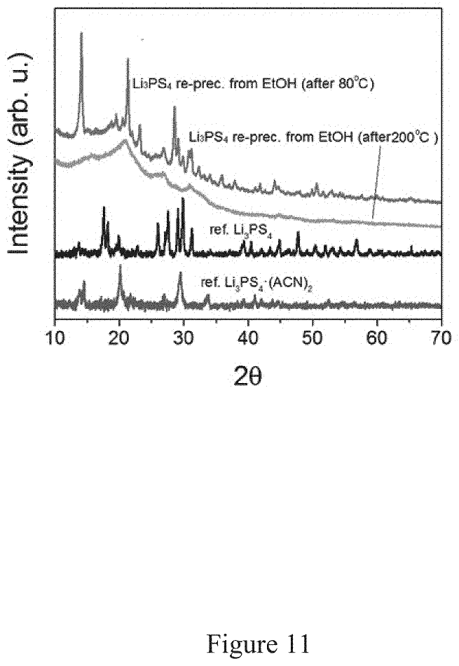

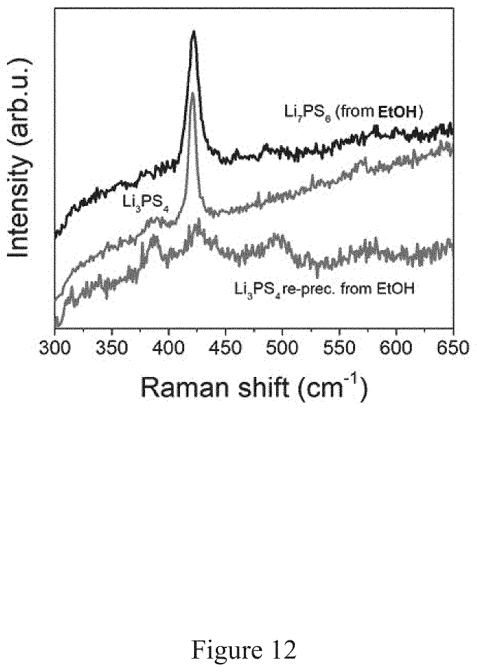

To further understand the reaction mechanism, the dissolution and re-precipitation process of Li₃PS₄ in ethanol was studied and compared with the case in acetonitrile. FIG. 10 demonstrates that Li₃PS₄ forms a complex of Li₃PS₄.(ACN)₂ in acetonitrile reverting to pure phase back after heat treatment. In contrast, the re-precipitated Li₃PS₄ material from ethanol shows unknown crystal structure after drying at 80° C. and exhibits amorphization after heating at above 150° C. (see FIG. 11). The reference bands in FIG. 11 show the Li₃PS₄ re-prec is different with Li₃PS₄ and Li₃PS₄ACN. As shown in FIG. 12, the structural change of Li₃PS₄ in ethanol is further supported by the Raman spectra, in which the characteristic peak of (PS₄)³⁻ group vibration is not observed. Nevertheless, with the existence of Li₂S in ethanol, the cubic phase of Li₇PS₆ can be successfully produced from Li₃PS₄ without any other crystal phase.

### Morphological Analysis

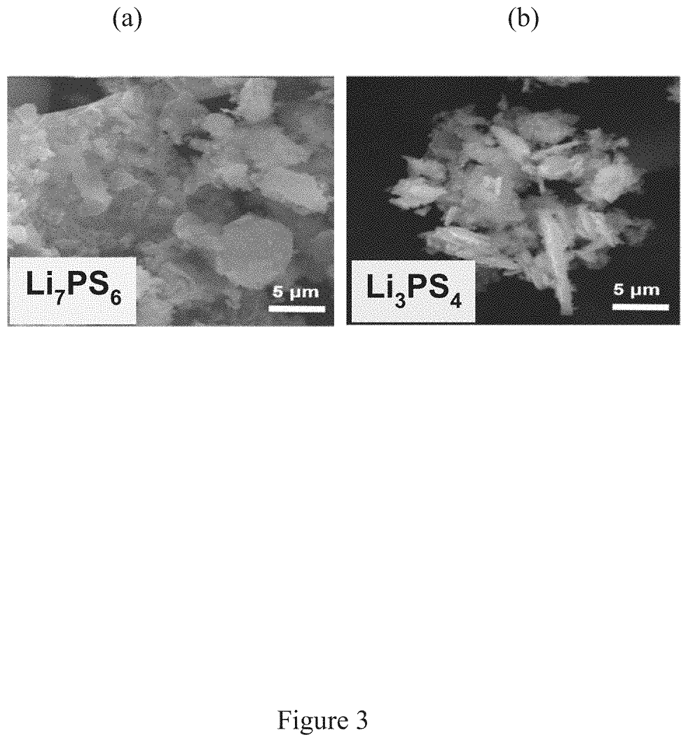

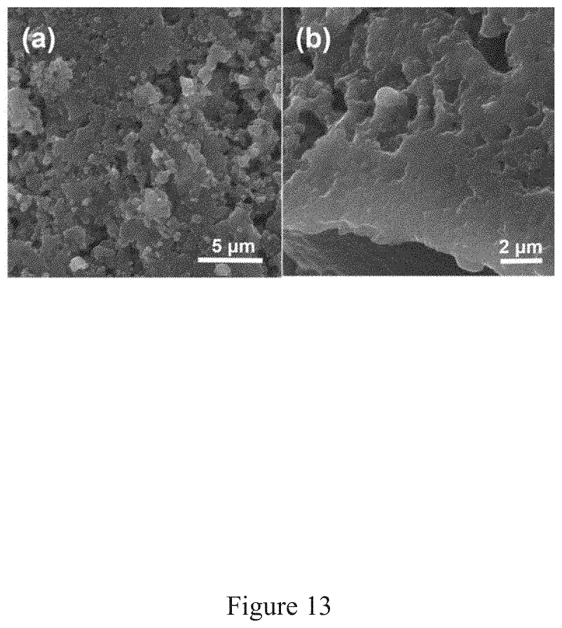

According to multiple embodiments and alternatives, the morphology variation from Li₃PS₄ precursor to Li₇PS₆ product was also analyzed using SEM. As shown in FIG. 3 (panel b), the Li₃PS₄ sample prepared from ACN has an interesting flake-like morphology. In contrast, as shown in FIG. 3 (panel a), the Li₇PS₆ product shows a granular nano-sized morphology (agglomerated particles of about 100 nm size). The difference in morphology of these samples is related to the solvent involved in the synthesis. As shown in FIG. 13, Li₃PS₄ dissolved in ethanol and the re-precipitated sample displays a grainy shape.

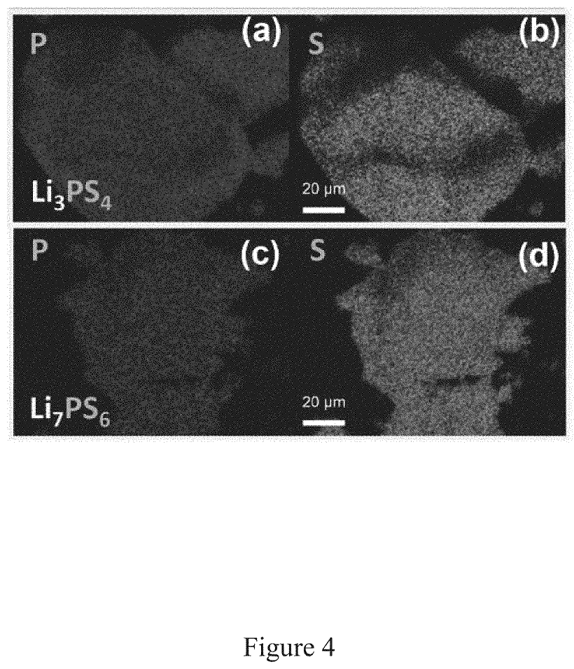

EDX analysis of the Li₃PS₄ precursor and final Li₇PS₆ product is shown in FIG. 4. The distribution of P and S atoms is practically the same for both materials, indicating homogeneity through liquid synthesis methods. The calculated ratio between P and S atoms in these samples are 1:3.2 and 1:4.6, respectively, which can indicate elemental disturbance at the surface of the materials.

### Conductivity and Stability Measurements

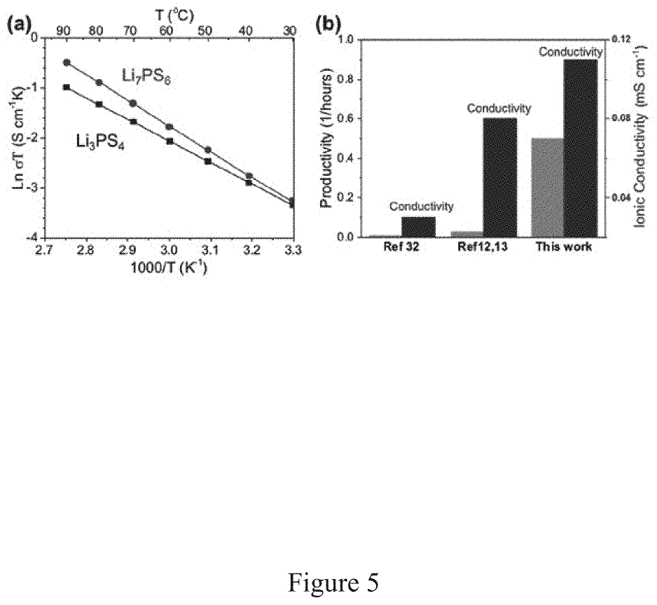

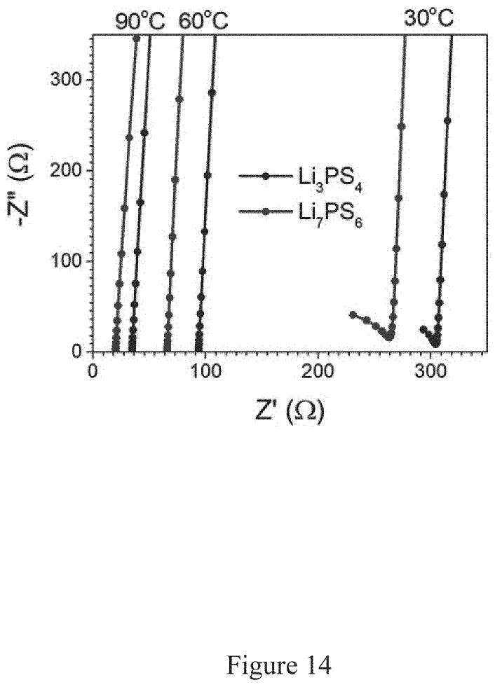

EIS were employed to measure the conductive properties of both cubic Li₇PS₆ and β-Li₃PS₄. As shown in FIG. 5 (panel a), the synthesized Li₇PS₆ has an ionic conductivity of about 0.11 mScm⁻¹ to 0.5 mScm⁻¹ at about room temperature, which is a much higher value compare to a previous report from the liquid synthesis of Li—P—S argyrodite. Furthermore, the synthesized Li₇PS₆ has an ionic conductivity of about 1.5 mScm⁻¹ at about 90° C. The Nyquist plots of Li₇PS₆ and β-Li₃PS₄ (as shown in FIG. 14) show both solid electrolytes have decreased total resistance with increasing temperature. Compared with β-Li₃PS₄, Li₇PS₆ exhibits faster Li-ion mobility at elevated temperatures. For instance, the ionic conductivity of Li₇PS₆ is 1.5×10⁻³ S cm⁻¹ at 90° C. while 1.0×10⁻³ S cm⁻¹ for Li₃PS₄ at the same temperature. The activation energy of Li₇PS₆is determined to be 38.73 kJ mol⁻¹ (0.4 eV), whereas Li₃PS₄ is equal to 32.39 kJ mol⁻¹ (0.336 eV).

FIG. 5 (panel b) compares the conductivities and productivity for Li₇PS₆ prepared through different methods: 3×10⁻⁵ S cm⁻¹ (conventional solid state reaction at 650° C. for 7 days, represented by “Ref 32” in FIG. 5), 8×10⁻⁵ S cm⁻¹(conventional crystal powder from solid state reaction, 40 hours, represented by “Ref 12, 13” in FIG. 5), and methods according to the present disclosure: 1.1×10⁻⁴ S cm⁻¹ (liquid synthesis approach, 2 hours, represented by “This work” in

FIG. 5). In FIG. 5 (panel b), the lighter bars represent the productivity and the darker bars represent the conductivities. Both synthetic approaches of solid-state reaction and mechanical milling require the reaction time longer than 40 hours and the yielded products show conductivity values of 10⁻⁵-10⁻⁴ S cm⁻¹. In contrast, the Li₇PS₆ synthesis according to multiple embodiments and alternatives can be completed in 2 hours. The findings from the present disclosure suggest that reacting and nucleating Li₇PS₆ crystals straight from the solution is beneficial for the final ionic conductivity. In addition, the ionic conductivity value of Li₇PS₆ from the present disclosure is also close to other Li₂S—P₂S₅ family materials previously prepared by solid-state methods (e.g., glasses and glass-ceramics).

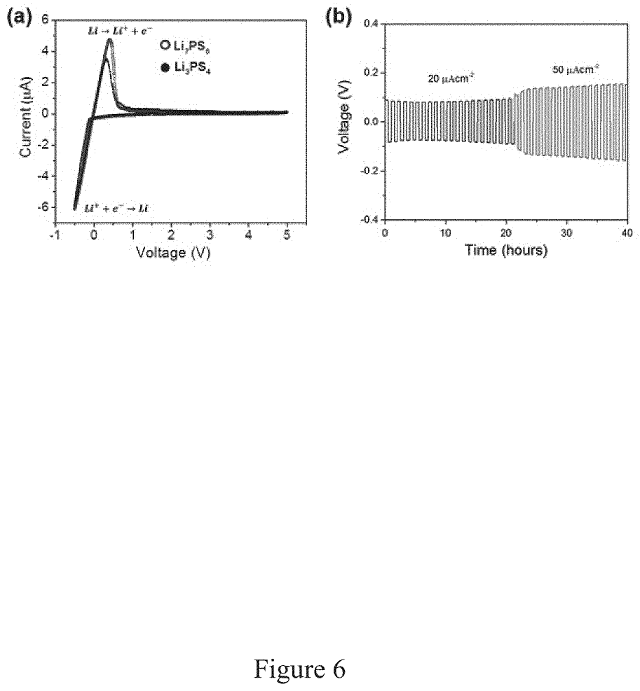

As shown in FIG. 6 (panel a), the electrochemical stability between the synthesized Li₇PS₆ and metallic Li was investigated by cyclic voltammogram (CV) of a Li/Li₇PS₆/Pt cell, in which Li and Pt serve as the reference/courter electrode and working electrodes, respectively. The potential was scanned from −0.5 to 5.0V (vs. Li⁺/Li) at a scan rate of 50 mVs⁻¹. As illustrated in FIG. 6 (panel a), for both solid electrolytes (cubic Li₇PS₆ and β-Li₃PS₄), a pair of reversible oxidation and reduction peaks is observed at around 0 V (vs. Li⁺/Li) without any other side reaction. Furthermore, the cathode current below 0 V is a Li deposition on working electrode (Li⁺+e⁻→Li), whereas the anode current above 0 V results from reversible lithium dissolution. The CV curves illustrated in FIG. 6 (panel a) indicate that Li₇PS₆, synthesized in accordance with multiple embodiments and alternatives, exhibits as good stability with Li anode as Li₃PS₄ over a broad electrochemical window (up to 5 V).

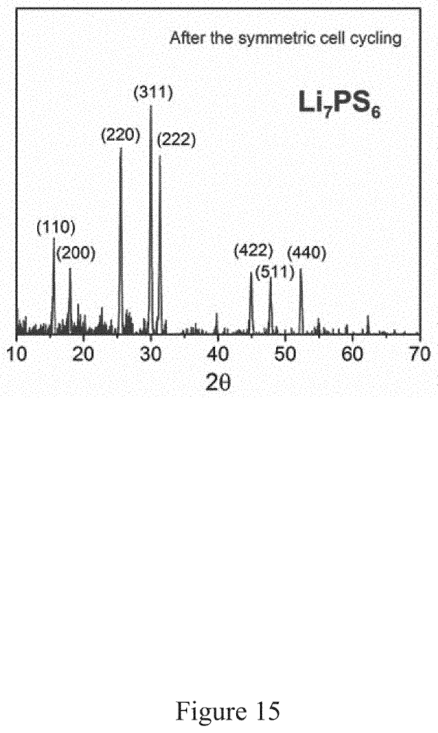

A symmetric cell of Li/Li₇PS₆/Li was configured to demonstrate the compatibility of Li₇PS₆ solid electrolyte with metallic Li under a current density of 50 μAcm⁻² at room temperature and the results are shown in FIG. 6 (panel b). The values of overpotential for the symmetric cell are lower than 20 mV with a slight increase as cycling continues, suggesting the possible interfacial reactions between Li anode and Li₇PS₆ solid electrolyte. Nevertheless, after cycling, shiny Li surface was still observed when peeling it off from Li₇PS₆ solid electrolyte in the symmetric cell. The XRD patterns of the solid electrolyte pellet after cycling (shown in FIG. 15) show characteristic peaks of Li₇PS₆, which indicates that the interfacial reaction is not severe.

In summary, crystalline lithium argyrodite solid electrolyte was rapidly and economically synthesized through the stoichiometric chemical reaction of Li₂S and Li₃PS₄ in ethanol medium. The synthesized Li₇PS₆ has the room temperature ionic conductivity of at least 0.11 mS cm⁻¹ at room temperature and 1.5 mS cm⁻¹ at 90° C., a desirable value among pure materials prepared through liquid synthesis, and 40% higher than those crystalline Li₇PS₆ powders from other synthesis methods (i.e. solid-state reaction and ball milling). Furthermore, the synthesized Li₇PS₆ is highly compatible with the metallic Li anode. Accordingly, methods for wet chemical synthesis of lithium argyrodites, according to multiple embodiments and alternatives, leads to high purity phase of Li₇PS₆ material with scalable and simple processing steps. Moreover, inventive methods for wet chemical synthesis of lithium argyrodites further position Li₇PS₆ as a desirable electrolyte candidate in the large-scale all-solid-state battery technology.

### Example 2—Wet Chemical Synthesis of Li₆PS₅X, where X=Cl, Br, or I

Synthesis of Li₃PS₄ precursor—As illustrated in FIG. 7, the Li₂S and P₂S₅ with a stoichiometry of 3:1 is dissolved in acetonitrile (ACN), stirred for 8 h at room temperature and then filtrated. The obtained white powder is then dried at 80° C. under vacuum to remove excess solvent yielding Li₃PS₄.(ACN)₂. Further heat treatment above 150° C. produces β-Li₃PS₄.

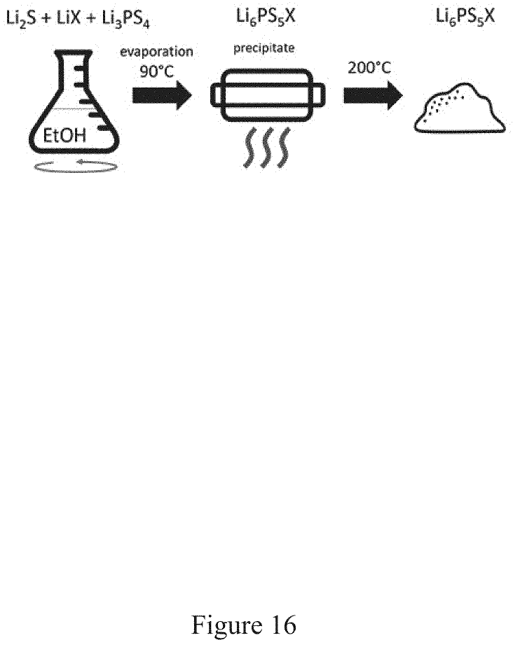

Synthesis of Li₇PS₅X electrolyte—As illustrated in FIG. 16, the Li₆PS₅X electrolyte (where X=Cl, Br, or I) was efficiently synthesized using a wet chemical method according to multiple embodiments and alternatives. A stoichiometric mixture of Li₂S, Li₃PS₄.(ACN)₂ and LiX (X=Cl, Br, I) was dissolved in a small quantity of anhydrous ethanol (25 ml) in argon atmosphere. To bypass the P₂S₅ insolubility problem, pure Li₃PS₄ precursor was used. Next, the solvent was evaporated at 90° C. under vacuum until a white precipitate was present (not longer than 1 hour, preferably 40-50 minutes). The heat treatment continued above 150° C. (1 hour) and got a final product (Li₆PS₅Cl, Li₆PS₅Br, and Li₆PS₅I respectively) synthesized according to multiple embodiments and alternatives. As previously noted, the chemical reaction for the synthesis of Li₆PS₅X electrolyte is expressed by:

$$L {i}_{3} P {S}_{4} + L {i}_{2} S + LiX {\to }^{etha nol} {Li}_{6} P {S}_{5} X \qquad Equation ( 2 )$$

Structural and Morphological Investigation—The phase composition and crystal structure of the final product were examined using X-ray diffraction (Bruker D8 Discover) with nickel-filtered Cu-Kα radiation (λ=1.5418 Å). The crystallite size of the obtained materials was estimated using the Scherrer equation. In addition, the chemical and structural data was obtained from the Raman spectroscopy measured by Renishaw in Via Raman/PL Microscope with a 632.8 nm emission line of a HeNe laser. TESCAN Vega3 scanning electron microscope (SEM) was used to study the morphology of the samples synthesized according to multiple embodiments and alternatives.

Electrochemistry and conductivity—Electrochemical impedance spectroscopy (EIS) were performed to measure the ionic conductivities of produced samples in the frequency range from 1 MHz to 100 mHz with an amplitude of 50 mV using Bio-Logic VSP300. Measurements were done using dense pellets (½″ diameter) prepared by a cold pressing of powders between two electrodes of conductive carbon on aluminum current collector (blocking electrode) and placing them in homemade press cells. As expected for pure ionic conductor, EIS spectra present a semi-arc at high frequencies and a straight line at lower frequencies. The straight line intercept at the X axis is employed to determine the total ionic conductivity of the material. In addition, the temperature dependent spectra were recorded from room temperature to 90° C. to obtain the Arrhenius plot. Swagelok cells were also used to complete cyclic voltammetry (CV) and cycling performance measurements. For CV test, Li/SE/Pt cells were scanned at 50 mV s⁻¹ rate between −0.5 and 5V vs. Li/Li⁺ at room temperature using. For symmetric cell cycling, the Li/SE/Li symmetric cell were assembled and cycled on a battery system (Bio-Logic VSP) with current densities of 50 μA cm⁻².

### Results and Discussion

Crystal Structure Analysis of Anionic Substituted Li₆PS₅X

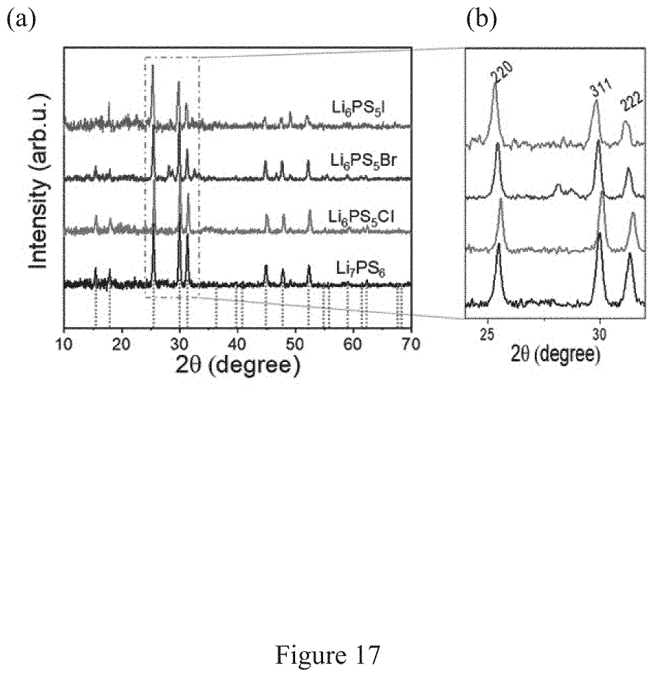

As illustrated in FIG. 16, for Li₆PS₅X (where X=Cl, Br or I) synthesis, stoichiometric mixtures of Li₃PS₄, Li₂S and LiX (where X=Cl, Br or I) were dissolved in anhydrous ethanol, stirred, and followed by a heat treatment above 150° C., yielding white powders for halide doped lithium argyrodites. The final products synthesized according to multiple embodiments and alternatives were characterized by XRD (as shown in FIG. 17), and were identified as Li₆PS₅Cl, Li₆PS₅Br, and Li₆PS₅I, corresponding to LiCl, LiBr and LiI reactants, respectively. Similar to the case of the pure Li₇PS₆ powder from Example 1, all halide doped samples display several sharp peaks at 2θ≈25.5, 30, 31.2°, attributing to (220), (311), and (222) planes in cubic phase (space group F-43m), but with a slight peak shift due to the subtle change on unit cell parameters. The set of unit cell parameter, crystal size, ionic radius of the halides and sulfide anions for Li₇PS₆ and Li₆PS₅X are presented in Table 1.

TABLE 1
Structural and Spectral Properties of
Li₇PS₆ and Li₆PS₅X lithium argyrodite samples.

| | Crystal | Unit cell | Ionic | Raman | | | |
|---|---|---|---|---|---|---|---|
| | Size | parameter | radius | shift | FWHM | Eₐ | |
| Sample | (nm) | (A) | (pm) | (cm⁻¹) | (cm⁻¹) | (kJ/mol) | Eₐ (eV) |
| Li₇PS₆ | 34 | 9.88 | (S⁻²) 170 | 421.5 | 10.7 | 41.46 | 0.430 |
| Li₆PS₅Cl | 45 | 9.84 | (Cl⁻) 167 | 425.1 | 10.7 | 38.57 | 0.400 |
| | | | | 392.6 | 16 | | |
| Li₆PSₛBr | 39 | 9.89 | (Br⁻) 182 | 423.3 | 9 | 40.24 | 0.417 |
| | | | | 388.8 | 12 | | |
| Li₆PS₅l | 32 | 9.95 | (I⁻) 206 | 422.7 | 11.6 | 40.47 | 0.419 |
| | | | | 390.1 | 17 | | |

Based on the results shown in Table 1, the lattice parameter a decreases from 9.88 A for Li₇PS₆ to 9.84 Å for Li₆PS₅Cl and then increases to 9.89 Å for Li₆PS₅Br and 9.95 Å for Li₆PS₅I, respectively. This trend is consistent with the ion's radius variations, due to Cl⁻ (167 pm)<S²⁻ (170 pm)<Br⁻ (182 pm)<I⁻ (206 pm). Larger anions (Br⁻ and I⁻) lead to the expansion of the lattice parameter in the cubic structure. This observation fits well with the trend from the previous experimental reports on the Li₆PS₅X series. Due to stoichiometric amounts of used ingredients in liquid-based synthesis method, the final products are mostly free from impurities. Only in the case of Li₆PS₅Br, were trace amounts of LiBr observed. It is important to mention that the preparation time of these solid electrolyte materials according to the disclosure herein is only about 2 hours. On the other hand, the preparation time for ball-milling takes at least 5 hours (and up to 4 days), not even counting the much longer heating/cooling process required for full crystallization to occur (e.g. 5 hours and up to 7 days).

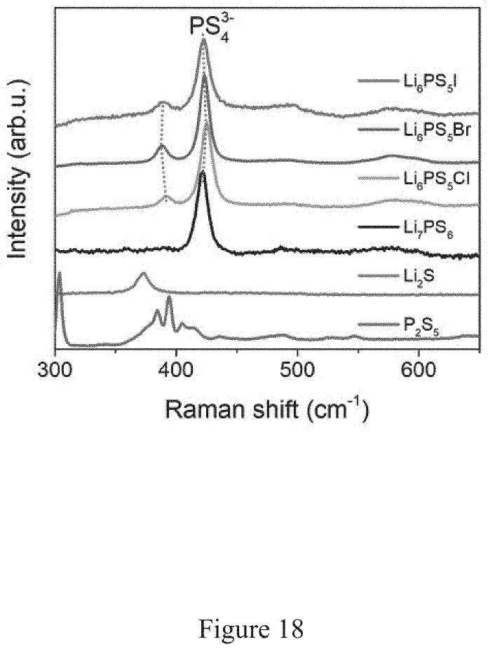

To confirm the crystal structure, the Raman spectra of of Li₆PS₅X samples (Li₆PS₅Cl, Li₆PS₅Br, and Li₆PS₅I), were collected and compared with that of pure Li₇PS₆, as shown in FIG. 18. Similar with Li₇PS₆ material, all three halide doped samples (Li₆PS₅X) exhibit strong lines in the range between 422 and 425 cm⁻¹ attributed to PS₄⁻³ ion vibration and the minor lines at about 390 cm⁻¹. The exact line positions and their full width at half maximum (FWHM) values are shown in Table 1 (above). The results indicate that PS₄⁻³ ion vibration is influenced by the surrounding halide ions which likely change the force constants and cause the evident peak shift. The Raman shift of PS₄⁻³ ion vibration decreases while the unit cell of argyrodite increases. The minor line mode can correspond to a trace of Li₄P₂S₆ and its P₂S₆⁻⁴ vibrational mode. For comparison, the Li₇PS₆ has a similar PS₄⁻³ vibrational mode at 421.6 cm⁻¹ as expected.

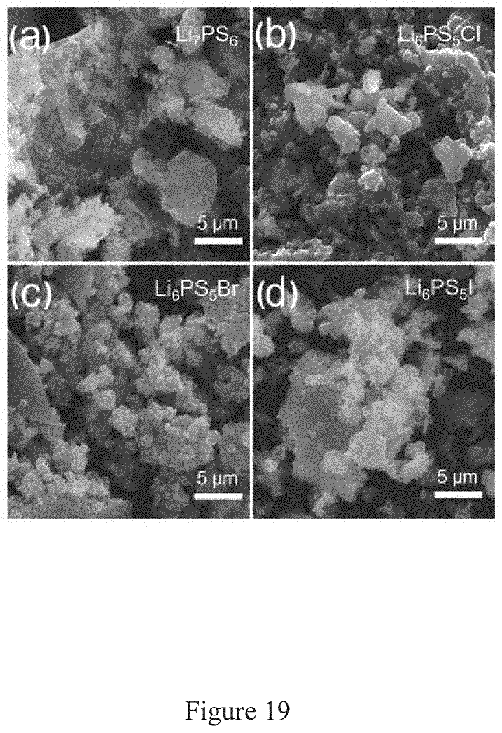

The morphology of the products synthesized according to present embodiments were also analyzed by SEM images. As previously stated, the solvent may play a role in the final morphology of the material. As shown in FIG. 19, the morphology of the Li₆PS₅X material series was compared to the Li₇PS₆ product prepared from ethanol. FIG. 19 illustrates that the reaction of Li₃PS₄, Li₂S, and LiX in ethanol solvent results in grainy nanosized morphology (agglomerated particles of about 500 nm size) as expected.

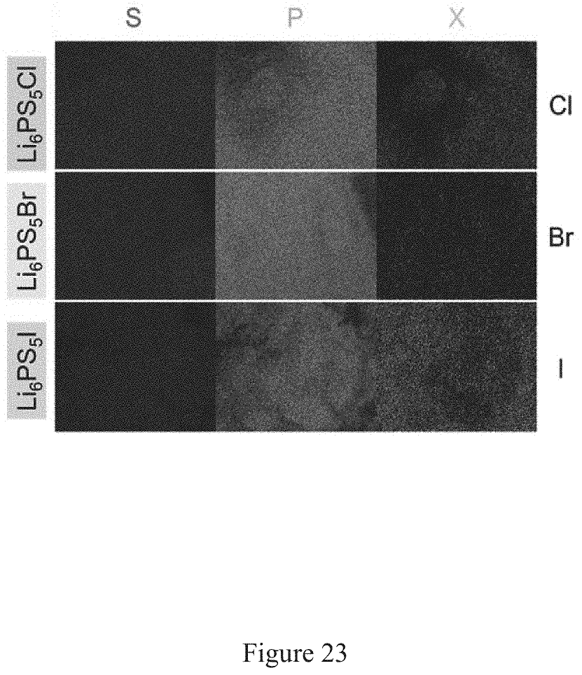

In addition, the EDX maps of the Li₆PS₅X (see FIG. 23) show uniform distribution of P, S, and X (Cl, Br, and I) atoms, suggesting a homogeneity in the final product after the liquid synthesis method, according to multiple embodiments and alternatives.

### Electrochemical Performance of Li₇PS₆ Electrolyte from Liquid Phase

The conductivity measurements in a blocking cell show that Li₆PS₅Cl and Li₆PS₅Br materials prepared according to the synthesis method disclosed herein have higher ionic conductivities than pure Li₇PS₆ samples. In particular, their values at room temperatures are 1.4×10⁻⁴ S cm⁻¹ and 1.2×10⁻⁴ S cm⁻¹ compared to 1.1×10⁻⁴ S cm⁻¹ of Li₇PS₆ material. This enhancement on ionic conductivity is closely related with the replacement of Cl and Br to S ions, which results in more defects in Li₆PS₅Cl and Li₆PS₅Br. As expected, the Li₆PS₅I shows the lower ionic conductivity of 2.9×10⁻⁵ S cm⁻¹ compared with its Cl— and Br— analogues. This effect was recently explained and experimentally proven by correlating the lattice softness with the ionic transport. The latest results suggest that the softer bonds lower the activation energy and simultaneously decrease the moving ion prefactor. The addition of Cl, Br, or I ions to the crystal structure leads to an obvious change in the unit cell volume (as illustrated in the XRD patterns shown in FIG. 17), as well as the lattice site disorder. The decreasing disorder increases the activation barrier of the ionic transport. The electrochemical performance results further confirm these theoretical findings.

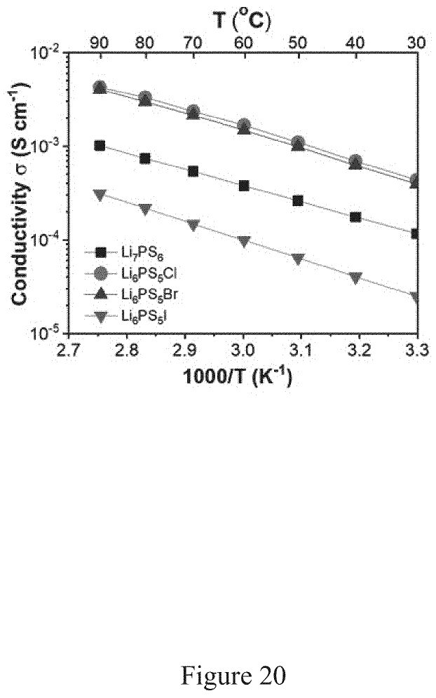

In addition to room temperature conductivity, the total activation energy of the prepared samples was calculated from the temperature dependent EIS spectra. FIG. 20 shows Arrhenius plots which reflect the temperature dependence of ionic conductivities for Li₆PS₅X (X=Cl, Br, I) samples and pristine Li₇PS₆. All materials show linear relations of ionic conductivity vs temperature, and the slopes are proportional to the activation energy (Eₐ) for Li-ion conduction according to the following equation:

$$σ = {σ}_{0} {e}^{\frac{{E}_{a}}{k T}} \qquad Equation ( 5 )$$

where σ is the photo-ionization cross-section, σ₀ is the pre-exponential photo-ionization cross-section, Eₐ is the activation energy, k is Boltzmann's constant, and T is the temperature. The activation energies of Li₆PS₅Cl, Li₆PS₅Br, and Li₆PS₅I are estimated to be 38.57 kJ mol⁻¹ (0.399 eV), 40.24 kJ mol⁻¹ (0.417 eV), and 40.47 kJ mol⁻¹ (0.419 eV) while Li₇PS₆ is equal to 41.46 kJ mol⁻¹ (0.430 eV), as specified in Table 1. The comparison indicates that introducing halide ions (X=Cl, Br, I) reduces the barrier for Li ion mobile along the framework and thus decreases the values of activation energy. The total activation energies of halide doped materials show lower values than pure Li₇PS₆. The Li₆PS₅Cl sample has the lowest activation energy and also shows the best conductivity among all doped samples. This suggests that Li₆PS₅Cl has the lowest barrier for lithium ions to move along the material. The main reason for the best conductivity of Li₆PS₅Cl is due to the distribution of disorder of Cl ions over the 4a and 4c sites together, which provides both high Li⁺ intercage jump rates and doublet jump rates in the Li₆PS₅Cl structure.

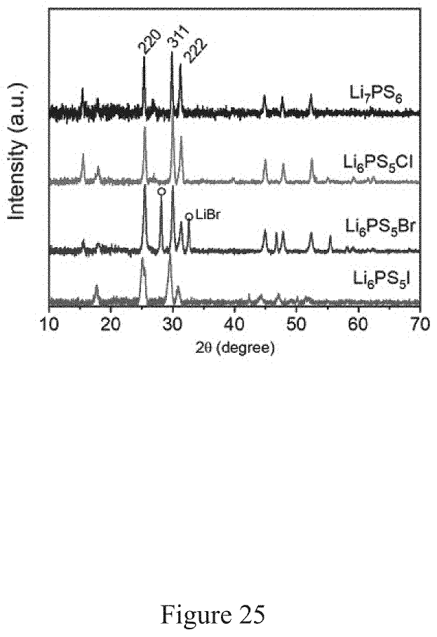

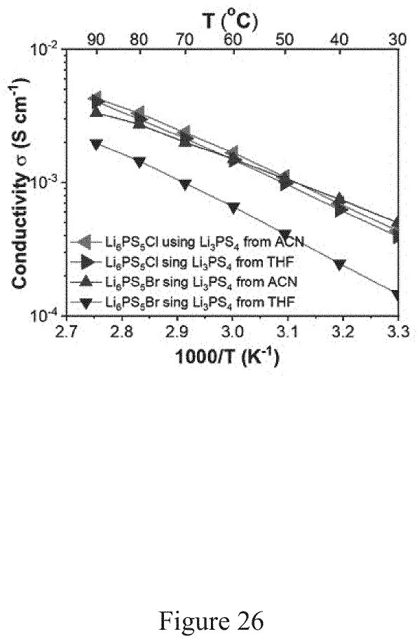

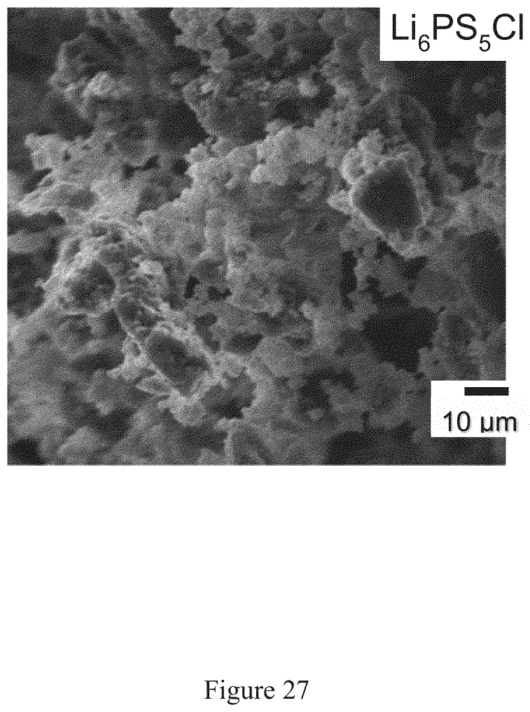

For a solvent-based synthesis method, Li₃PS₄ is the most important precursor to produce high purity Li₆PS₅X argyrodites. Previously, Li₃PS₄ was reported to yield either flaky or chunky morphology from different solvent-based processes. Accordingly, Li₃PS₄ precursors from two synthesis solvents (ACN and THF) were used to prepare Li₆PS₅X (X=Br, Cl) argyrodites following the inventive methods disclosed herein. The synthesized Li₆PS₅X (X=Br, Cl) solid electrolytes were characterized by XRD for phase identification (FIG. 25), which confirm the products of Li₆PS₅Cl and Li₆PS₅Br (containing a small amount LiBr). FIG. 26 shows the Arrhenius plots of Li₆PS₅Cl and Li₆PS₅Br, which display similar ionic conductivities (at least 0.1 mS cm⁻¹) between Li₆PS₅Cl (or Li₆PS₅Br) samples prepared using Li₃PS₄ from either ACN or THF. As shown in FIG. 26, Li₆PS₅C1 and Li₆PS₅Br displayed an ionic conductivity of about 0.11 mScm⁻¹ to 0.5 mScm⁻¹ at room temperature, and an ionic conductivity of about 1.5 mScm⁻¹ at about 90° C. SEM image shows granular morphology (FIG. 27). These observations indicate that the source of Li₃PS₄ doesn't have a significant influence on the structure, conductivity or morphology of solvent-synthesized Li₆PS₅X materials.

### CV Testing in a Symmetric Lithium Cell

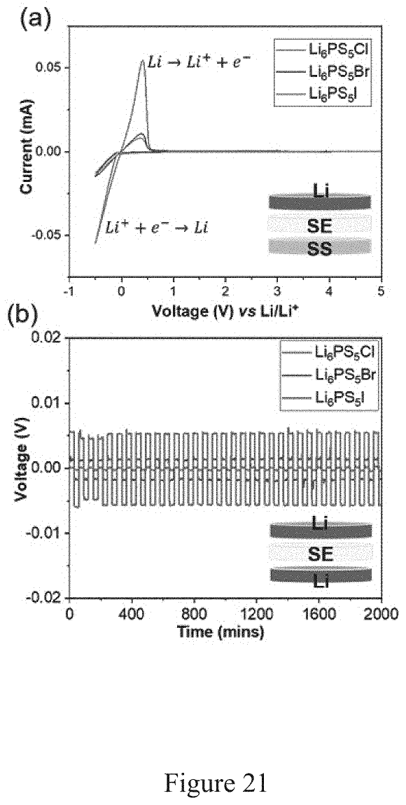

CV was employed to evaluate the electrochemical stability of solvent-synthesized Li₆PS₅X (X=Br, Cl, I) materials against Li metal in a voltage window of 0.5-5.0 vs Li/Li⁺ (FIG. 21). The assembled cells have structure of Li/Li₆PS₅X/SS, with Li as the reference/courter electrode and stainless steel (SS) as the working electrode. For all Li₆PS₅X (X=Br, Cl, I) materials, only one pair of oxidation and reduction peaks are observed near 0 V vs Li/Li⁺, attributing to the lithium dissolution (Li→Li⁺+e⁻) and lithium deposition (Li⁺ e⁻→Li), respectively. There is no other peak observed up to 5 V, suggesting good electrochemical stability of Li₆PS₅X (X=Br, Cl, I) solid electrolyte against Li metal in a cell structure of Li/SE/SS. Among them, Li₆PS₅Cl shows a highly desirable oxidative/reductive current.

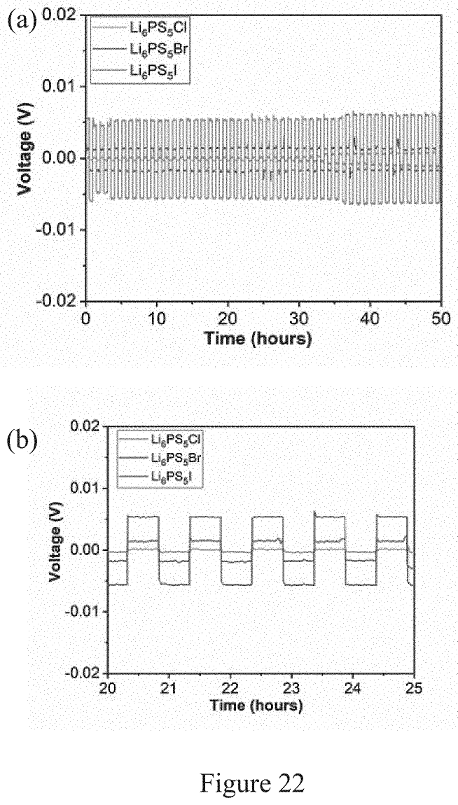

Symmetric cells of Li/Li₆PS₅X/Li were assembled to evaluate the long-term compatibility of liquid synthesized Li₆PS₅X with Li metal at room temperature. All the cells were cycled at room temperature with a current density of 20 uA cm⁻². FIG. 21 (panel b) and FIG. 22 show smooth cycling profiles for for these symmetric cells with Li₆PS₅X (X=Br, Cl, I) as solid electrolytes and the resulting voltages are stable over 3000 mins (50 cycles). However, the voltage for Li₆PS₅X-based symmetric cells follows a trend of (Li₆PS₅I)>(Li₆PS₅Br)>(Li₆PS₅Cl), which is in reverse with the ionic conductivity of solid electrolyte. Li₆PS₅Cl has a desirable ionic conductivity and lowest resistance, thus the lowest voltage under the same current density.

In conclusion, Li₆PS₅X argyrodite materials were successfully synthesized utilizing the synthesis method according to multiple embodiments and alternatives. The conductivity values at room temperature of the synthesized materials reached as high as 1.4×10⁻⁴ S cm⁻¹. Accordingly, inventive methods for wet chemical synthesis of lithium argyrodites, according to multiple embodiments and alternatives, also produce materials with high ionic conductivity, the possibility of further halide substituting tuning, and easier fabrication prospects. A significant advantage of the wet chemical synthesis method within the scope of embodiments is scalability, production of high quality thin film electrolytes, and selenium impregnation of electrodes. In addition, the shorter and more convenient material processing steps, without the ionic conductivity decrease, is an important advantage of the current method for wet chemical synthesis of lithium argyrodites.

### Example 3—Excess Chloride Doping Effect on Lithium Argyrodite Solid Electrolyte

Materials Synthesis—Since Li₆PS₅Cl exhibited a desirable ionic conductivity amongst three halogen ions, it was selected to study the effect of excess Cl content on the crystal structure, ionic conductivity, and electrochemical stability of LiCl rich argyrodites Li₆PS₅Cl.xLiCl (0≤x≤2). Accordingly, said Li₆PS₅Cl.xLiCl (0≤x≤2) materials were synthesized by dissolving Li₂S, LiCl and β-Li₃PS₄ in ethanol in an argon atmosphere, according to multiple embodiments and alternatives. In particular, Li₂S and LiCl were first dissolved in ethanol, followed by the addition of Li₃PS₄. The mixture was stirred for 0.5 hours and then dried above room temperature (i.e. 90°) under vacuum to evaporate the ethanol and then annealed above 150° C. to collect white powder. The Cl content in Li₆PS₅Cl.xLiCl (0≤x≤2) was tuned by controlling the amount of LiCl precursor. According to multiple embodiments and alternatives, the following ratios of LiCl:Li₃PS₄ were controlled at 1:1, 1.5:1, 2:1, 2.5:1, and 3:1 to obtain the samples of Li₆PS₅Cl, Li₆PS₅Cl.0.5LiCl (or Li_{6.5}PS₅Cl_{1.5}), Li₆PS₅Cl.LiCl (or Li₇PS₅Cl₂), Li₆PS₅Cl.1.5LiCl (or Li_{7.5}PS₅Cl_{1.5}), and Li₆PS₅Cl.2LiCl (or Li₈PS₅Cl₃), respectively. The chemical reaction is represented by:

$$( x + 1 ) LiCl + L {i}_{3} P {S}_{4} + L {i}_{2} S {\to }^{etha nol} {Li}_{6} P {S}_{5} Cl \cdot xLiCl \qquad Equation ( 3 )$$

Materials Characterization—To perform ionic conductivity measurements, 100 mg of the synthesized materials were pressed between carbon-coated aluminum (serving as blocking electrodes) into pellets under high pressure (i.e. 300 MPa) to a disk roughly 10 mm in diameter and 50 mm thick. The pellets were tested via a pressed cell using electrochemical impedance spectroscopy (EIS) and Arrhenius activation energy measurements in the frequency range of 5MHz-1Hz with an amplitude of 100 mV using Bio-Logic VSP300.

### Results and Discussion

### Cl-Doping Content Affects the Phase Purity

A method for wet chemical synthesis of lithium argyrodites was employed to synthesize Li₇PS₆ with different amount of Cl doping, with a general formula of Li₆PS₅Cl.xLiCl (0≤x≤2). As previously noted, the Cl content was controlled by tuning the stoichiometric ratio of LiCl precursor vs Li₃PS₄ (from 1:1 to 3:1) to obtain a series of samples (Li₆PS₅Cl, Li₆PS₅Cl.0.5LiCl, Li₆PS₅Cl.LiCl, Li₆PS₅Cl.1.5LiCl, and Li₆PS₅Cl.2LiCl).

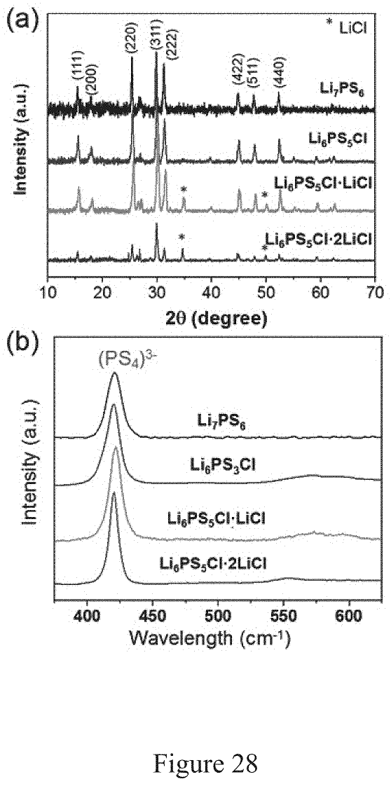

FIG. 28 (panel a) shows both the XRD patterns of Li₆PS₅Cl.xLiCl materials containing different amounts of Cl content as well as pure Li₇PS₆ without any Cl doping. Without Cl doping, cubic phase of pure Li₇PS₆ (space group F-43m) was obtained with the characteristic diffraction peaks at 2θ=25.5, 30, 31.2° corresponding to (220), (311) and (222) planes, respectively. When small amounts of LiCl are introduced, Li₆PS₅Cl has almost identical diffraction patterns to those of Li₇PS₆, suggesting the formation of a solid solution where Cl⁻ replaces S²⁻. As Cl content is increased, a secondary phase of LiCl (2θ=34.9°, 49.9°) is observed in addition to the dominant phase of Li₆PS₅Cl, and peak intensity continually increases with increasing LiCl. This observation indicates that the excess Cl cannot properly enter the Li₆PS₅Cl structure at highly doped samples after 200° C. heating treatment; instead, heterogeneous composite electrolytes of Li₆PS₅Cl.xLiCl are formed from the solvent-based synthesis method.

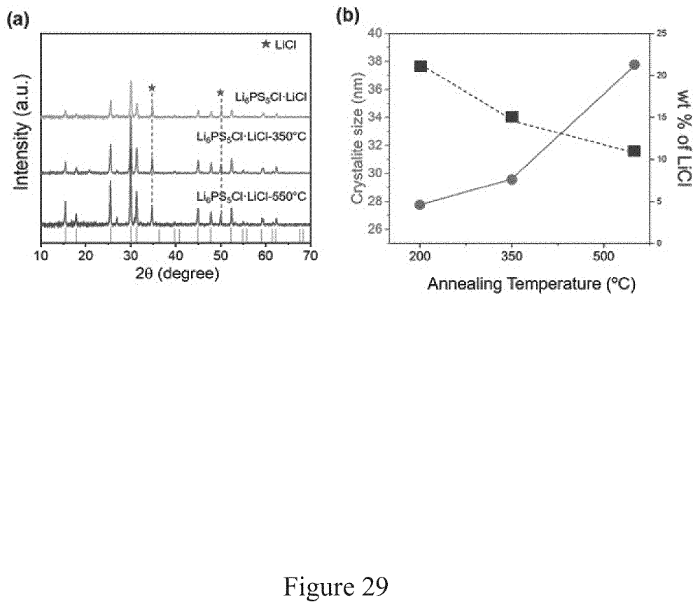

To study whether Cl can enter the Li₆PS₅Cl structure at a higher temperature, the obtained Li₆PS₅Cl.LiCl sample was further annealed in an Argon filled environment under 350° C. and 550° C. for 6 hours, respectively. Although LiCl diffraction peaks are still observed in annealed samples (as shown in FIG. 29), the weight ratio of LiCl to Li₆PS₅Cl decreases as the annealing temperature increases, indicating that excess Cl can partially enter Li₆PS₅Cl structure after high temperature annealing causing an increase of ionic conductivity (−1.9 10⁻³ mS cm⁻¹ for a sample annealed at 550° C.).

FIG. 28 (panel b) shows the Raman spectra of Li₇PS₆ and Cl-doped samples. The samples synthesized according to multiple embodiments and alternatives all exhibited a strong peak around 421-425 cm⁻¹, corresponding to the symmetric stretching mode of the P—S bond in the (PS₄)⁻³ vibrational mode. This peak is also the primary vibrational mode for argyrodite-type materials. The Cl-doping leads to a slight right shift of the dominate peak (to 425 cm⁻¹) and a broad bump around 575 cm⁻¹ which is attributed to the asymmetric PS₄³⁻ vibrational mode. However, the excess amount of LiCl does not result in an obvious change on Raman spectra.

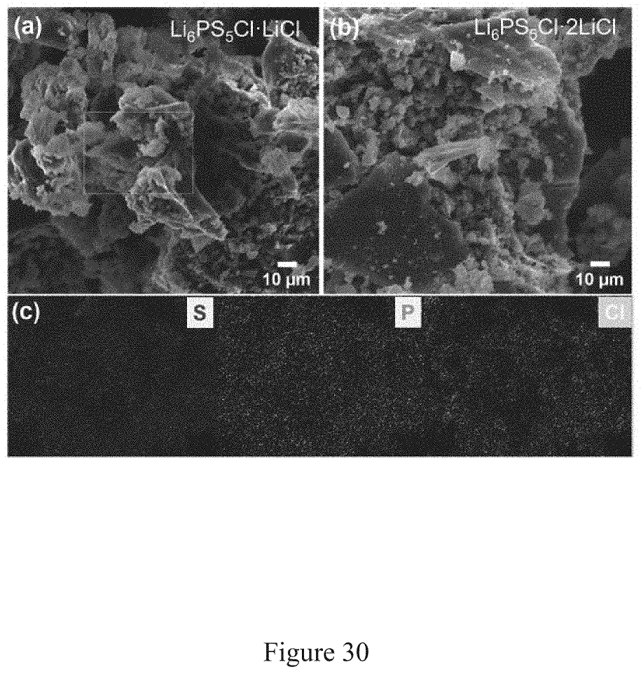

FIG. 30 shows the SEM images of Li₇PS₆, Li₆PS₅Cl, Li₅PS₄Cl₂ samples, produced in accordance with inventive methods disclosed herein. The SEM images (panels (a) and (b)) of the Li₆PS₅Cl.LiCl and Li₆PS₅Cl.2LiCl materials exhibit similar granular morphologies and homogeneous S, P, and Cl EDX mapping (panel c)).

### Conductivities Depend on Cl-Doping

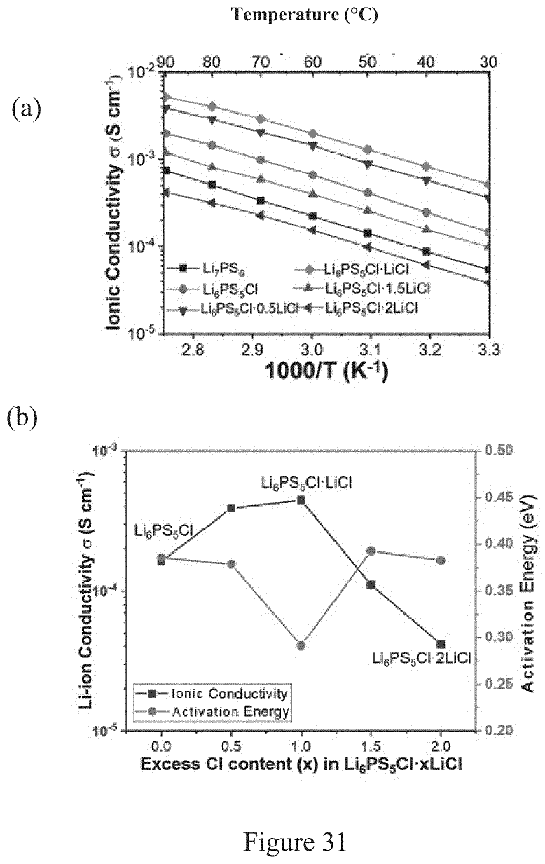

The Li-ion conductivities of Li₇PS₆ and Li₆PS₅Cl.xLiCl (x=0, 0.5, 1, 1.5, and 2) were evaluated by the electrochemical impedance spectra (EIS) measurements. For EIS tests, all powder samples were cold-pressed under 360 MPa with Al/C foils as the blocking electrodes. FIG. 31 (panel a) shows the Arrhenius plots of Li₇PS₆ and Li₆PS₅Cl.xLiCl (x=0, 0.5, 1, 1.5, and 2) with the temperature range up to 90° C. The conductivities of all samples increase linearly with increasing temperatures, and the slopes reflect the activation energy barriers for Li-ion diffusion across the crystalline framework. The compositional dependence between conductivities and activation energies for Li₆PS₅Cl.xLiCl (0≤x≤2) materials is shown in FIG. 31 (panel b). As Cl content increases, the room temperature ionic conductivity increases from 0.34 mS cm⁻¹ for Li₆PS₅Cl to the desirable value of 0.53 mS cm⁻¹ for Li₆PS₅Cl.LiCl and then decreases beyond it. Among them, Li₆PS₅Cl.LiCl exhibits the highest ionic conductivity (0.53 mS cm⁻¹ at room temperature) and the lowest activation energy (0.29 eV).

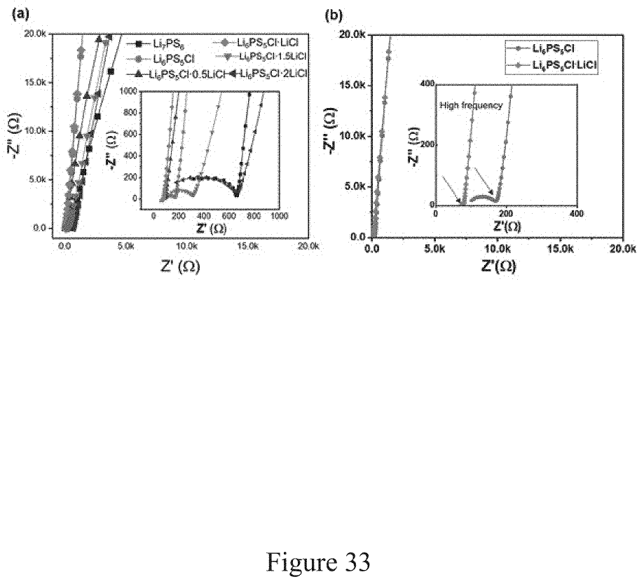

FIG. 33 panel (a) shows the Nyquist plots of lithium argyrodites with different Cl content Li₇PS₆ and Li₆PS₅Cl.xLiCl (x=0, 0.5, 1, 1.5, 2) at room temperature and panel (b) compares the Nyquist plots of Li₆PS₅Cl and Li₆PS₅Cl.LiCl. All the spectra consist of a semicircle at high frequency (the total resistance) and a spike at lower frequency (Li-diffusion from blocking electrode). In the case of Li₆PS₅Cl.LiCl, excess Cl exists in the form of LiCl instead of entering into the argyrodite's structure, thus the increased ionic conductivity can be explained by the space-charge effect in composites. Similar with other composites, the slight excess amount of LiCl may cause less resistance for the charged particles, which leads to enhanced Li-ion conductivity for the parent electrolyte (Li₆PS₅Cl). However, when the LiCl content is high, it will impede the forward motion of Li-ions since LiCl displays a worse room temperature conductivity (10⁻⁷ S cm⁻¹) than Li₆PS₅Cl. Notably, Li₆PS₅Cl.LiCl also exhibits the lowest activation energy of 0.29 eV, in comparison with 0.39 eV for Li₆PS₅Cl.

### Li₅PS₄Cl₂ Shows Better Electrochemical Performance

Cyclic voltammetry (CV) was employed to evaluate the electrochemical stabilities of Cl-doped LiₘPSₙClₒ samples with Li metal anode. The cell structure of Li/Liₓ₊₅PS_{6-X}Clₒ/SS was constructed in a Swaglock cell, with metallic Li serving as the reference electrode and stainless-steel (SS) acting as the working electrode. The CV scanning was collected in the potential range of −0.5 to 5V vs. Li/Li⁺ at a scan rate of 50 mV s−1.

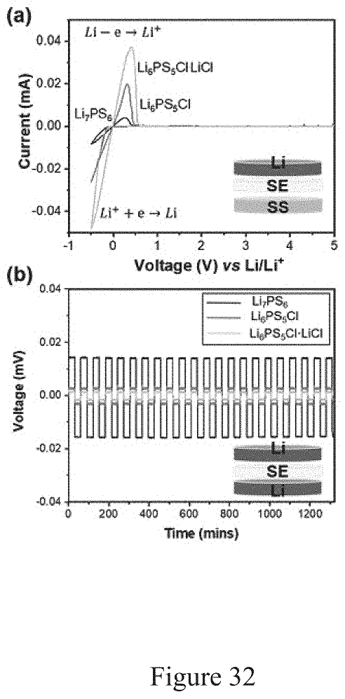

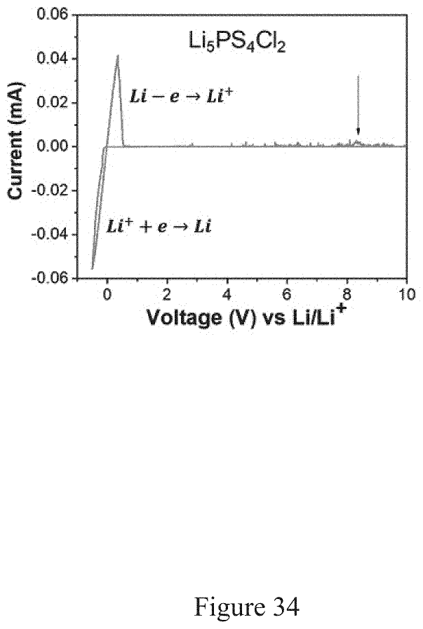

As shown in FIG. 32 (panel a), there is only a pair of oxidation (Li dissolution, Li→Li⁺+e⁻) and reduction (Li deposition, Li⁺+e⁻→Li) peaks near 0 V vs Li/Li⁺ without other side reactions, indicating good electrochemical stability with a Li anode. Li₆PS₅Cl.LiCl shows the highest values of anodic/cathodic current. In addition, symmetric cells of Li/Li₆PS₅Cl.xLiCl/Li were assembled to study long-term compatibility against Li metal. FIG. 32 (panel b) displays smooth voltage profiles for three solid electrolytes (Li₇PS₆, Li₆PS₅Cl and Li₆PS₅Cl.LiCl) under a constant current density of 0.02 mA cm⁻¹, suggesting good cyclability of these solid electrolytes in symmetric cells. Among the three solid electrolytes, Li₆PS₅Cl.LiCl exhibits the lowest polarization. Li₅PS₄Cl₂ also exhibits desirable values of anodic/cathodic current in CV curves, suggesting the lowest resistance in the Li/Li₅PS₄Cl₂/SS cell. FIG. 34 shows the CV scan of Li₅PSCl₂ carried out in a wider electrochemical window up to 10 V vs. Li/Li+. The CV curves are relatively flat in the range of 0.5-10 V except minor peaks around 7.5 V.

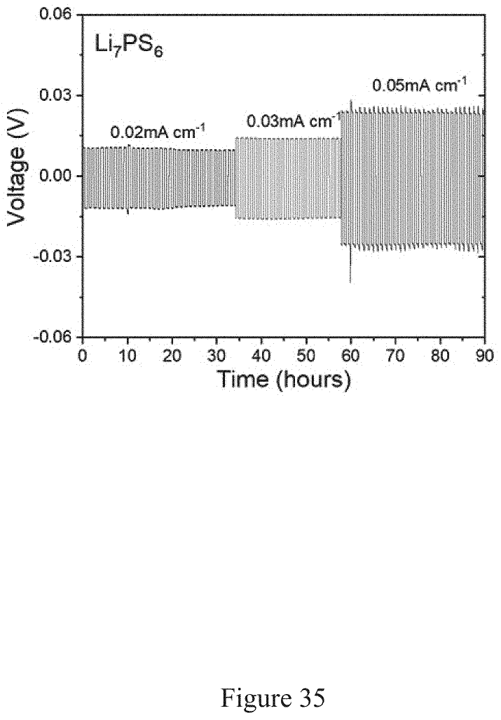

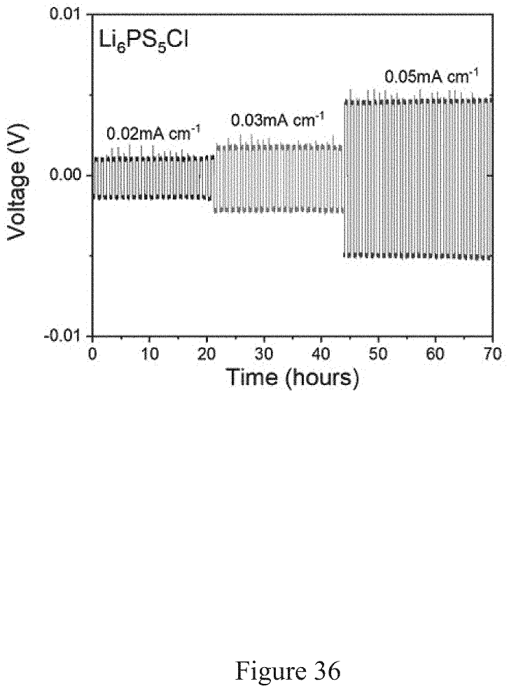

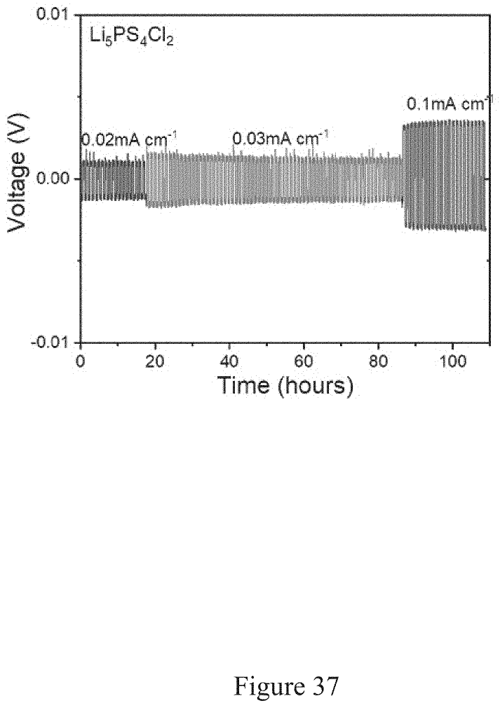

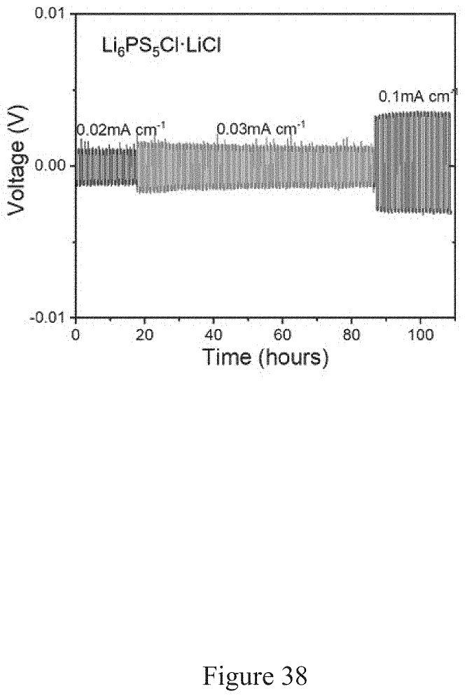

As illustrated in FIGS. 35-38, the Li/Li₅PS₄Cl₂/Li symmetric cell was demonstrated to cycle well under different current densities (0.02, 0.03 and 0.05 mA cm−1). By replacing nonbonded S⁻² with Cl in Li₆PS₅Cl, Li₅PS₄Cl₂ is believed to increase the interface stability. When higher densities are applied (as shown in FIG. 38), Li₆PS₅Cl.LiCl was also demonstrated to show better electrochemical stability with Li anode in comparison with Li₆PS₅Cl, Li₇PS₆, and Li₅PS₄Cl₂ in symmetric cells (FIGS. 35-37).

In summary, a solvent-based synthesis method according to multiple embodiments and alternatives was employed to investigate the effects of halide anion doping on the structure and properties of liquid synthesized lithium argyrodites. Pure phase Li₆PS₅X (X=Cl, Br, I) was obtained through a stoichiochemical reaction of LiX, Li₂S and Li₃PS₄ in ethanol solvent. In line with solid-state synthesized Li₆PS₅X materials, Li₆PS₅Cl argyrodite showed a desirable room temperature ionic conductivity of 0.34 mS cm⁻¹, followed by Li₆PS₅Br and then Li₆PS₅I. When excess Cl was introduced, Li₆PS₅Cl.xLiCl composites were obtained instead of a solid solution, suggesting excess Cl cannot enter the argyrodite structure. As Cl content increased, Li₆PS₅Cl.LiCl composite electrolyte exhibited a desirable ionic conductivity of 0.53 mS cm⁻¹ at room temperature (5×10⁻³ S cm⁻' at 90° C.), which then decreased as Cl content was further increased. The CV and symmetric cell cycling results indicate that solvent-synthesized halide doped lithium argyrodites (Li₆PS₅Cl, Li₆PS₅Br and Li₆PS₅I, Li₆PS₅Cl.LiCl) had good electrochemical stability with Li metal.

### Example 4—Electrochemical Energy Storage Device Fabrication

Synthesis—The battery performance of the solid electrolytes, synthesized according to multiple embodiments and alternatives, was tested with Li₄Ti₅O₁₂ (LTO)/Li cells, wherein LTO serves as the cathode and lithium as the anode in the cell (as non-limiting examples). To prepare the electrode, LTO nanopowder, polyvinylidene fluoride (PVDF) and Super P carbon black (80:10:10 in weight ratio) were mixed in N-methylpyrrolidone (NMP) to form a homogeneous slurry which was subsequently coated on aluminum foil. The prepared electrodes, with an active material loading of around 2.4 mg cm⁻², were dried at 80° C. for 24 h under vacuum prior to use. Thin Li foil (˜120 μm, as a non-limiting example) was used as the anode. The solid electrolyte compositions (Li₆PS₅Cl or Li₆PS₅Cl.LiCl as non-limiting examples) were cold-pressed to dense pellets with a thickness of around 500 μm and ½ inch diameter. Prior to electrochemical tests, trace amount of propylene carbonate/LiTFSI (Lithium bis(trifluoromethanesulfonyl)imide) electrolyte was added at both sides of the solid electrolyte pellet. Charge and discharge tests were performed over 1.0-3.0 V with 2032-coin cell after the cells were rested for 8 h.

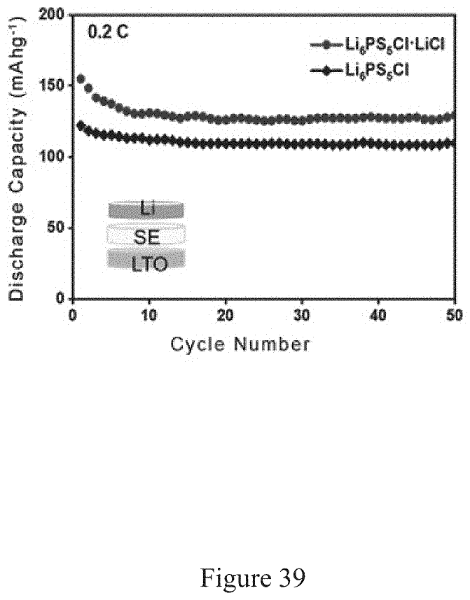

Cycling Results—All solid-state Li/Li₄Ti₅O₁₂ (LTO) batteries were assembled with Li₆PS₅Cl or Li₆PS₅Cl.LiCl as the respective solid electrolyte compositions, according to multiple embodiments and alternatives. FIG. 39 displays the cycling performance of Li/LTO cells at a C-rate of 0.2 C within a voltage range of 1.0-3.0 V. In batteries, the discharge current is often expressed as a C-rate in order to normalize against battery capacity. A C-rate is a measure of the rate at which a battery is discharged relative to its maximum capacity. In comparison, the cell with LiCl rich solid electrolyte composition shows a higher specific capacity (135 mAh g⁻¹) than Li₆PS₅Cl-based cell (110 mAh g⁻¹) after 50 cycles of charge/discharge, suggesting the positive role of excess Cl on the enhancement of electrochemical properties. The presence of lithium halide at the interface likely stabilizes the solid electrolyte composition/electrode interface and blocks side reactions. Accordingly, the improved cycling performance of the ASSB with Li₆PS₅Cl.LiCl as the solid electrolyte composition (as shown in FIG. 39) likely relates to the formation of a more stable solid electrolyte interphase layer due to the excess amount of Cl.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

Claims what is claimed is:

1. An electrochemical energy storage device comprising a solid electrolyte composition, wherein the solid electrolyte composition comprises a solid, halide-containing crystalline lithium argyrodite characterized by an ionic conductivity of at least 0.1 mS cm⁻¹ at about 22° C., wherein a molar ratio of sulfur to halide is in a range of 1.5:1-5:1.

2. The electrochemical energy storage device of claim 1, wherein the molar ratio of sulfur to halide is at least 2.5:1.

3. The solid electrolyte composition of claim 1, wherein the solid, halide-containing crystalline lithium argyrodite is characterized by an ionic conductivity in the range of 0.1 mS cm⁻¹ to 0.5 mS cm⁻¹ at about 22° C.

4. The solid electrolyte composition of claim 1, wherein the solid, halide-containing crystalline lithium argyrodite is characterized by an ionic conductivity of least 1.5 mS cm⁻¹ at 90° C.

5. The electrochemical energy storage device of claim 1, wherein the device is an all-solid state battery.

6. The electrochemical energy storage device of claim 5, wherein the device when cycling at a C-rate of 0.2 C is characterized by a specific capacity greater than 110 mAh g⁻¹ after 50 cycles of charge/discharge.

7. A method for synthesizing lithium argyrodites, comprising:
dissolving a mixture of precursors in a solvent;
drying the mixture above about 22° C. in a chamber by flowing an inert gas into the chamber or applying a vacuum within the chamber to yield a precipitate; and
annealing the precipitate at a temperature higher than 150° C. under vacuum or the inert gas atmosphere to yield a lithium compound having an argyrodite crystal structure.

8. The method of claim 7, wherein the drying and annealing steps are performed in about 2 hours or less.

9. The method of claim 7, wherein the lithium compound having an argyrodite crystal structure exhibits an ionic conductivity in the range of 0.1 mS cm⁻¹ to 0.6 mS cm⁻¹ at about 22° C.

10. The method of claim 7, wherein the lithium compound having an argyrodite crystal structure exhibits an ionic conductivity of at least 1.5 mS cm⁻¹ at 90° C.

11. The method of claim 7, wherein the precursors comprise Li₂S combined with one of Li₃PS₄, Li₃PS₄-ACN, or Li₃PS₄-THF.

12. The method of claim 7, wherein the precursors comprise Li₃PS₄, Li₂S, and LiX, where X represents at least one halide or a combination of halides.

13. The method of claim 7, wherein the lithium compound having an argyrodite crystal structure is characterized by an XRD pattern having a peak at 26+/−1 degree, a second peak at about 30 degrees, and a third peak at about 31 degrees.

14. The method of claim 7, wherein the lithium compound having an argyrodite crystal structure is represented by a formula chosen from the group consisting of LiₘPSₙXₒ and LiₘPSₙ, where m is a number in the range of 4-8, n is a number in the range of 3-6, X represents at least one halide, and o is a number in the range of 0-3.

15. The method of claim 7, wherein the lithium compound having an argyrodite crystal structure has a chloride content expressed as Li₆PS₅Cl.xLiCl wherein x is between 0-2.
